(19) United States
(12) Patent Application Publication
(10) Pub. No.: US 2026/0242251 A1
(43) Pub. Date: Aug. 20, 2026

(54) METAL-FREE CATALYST FOR DYE DEGRADATION AND METHOD OF PREPARATION THEREOF

(71) Applicant: KING FAHD UNIVERSITY OF PETROLEUM AND MINERALS, Dhahran (SA)

(72) Inventors: Mahmoud Atef ABDULHAMID, Dhahran (SA); Zainah Ali ALDHAWI, Dhahran (SA)

(73) Assignee: KING FAHD UNIVERSITY OF PETROLEUM AND MINERALS, Dhahran (SA)

(21) Appl. No.: 19/196,943

(22) Filed: May 2, 2025

Related U.S. Application Data
(60) Provisional application No. 63/761,099, filed on Feb. 20, 2025.

(51) Int. Cl. C02F 1/32; B01J 21/18; B01J 35/33; B01J 35/61; B01J 35/63; B01J 35/64; B01J 37/02; B01J 37/06; B01J 37/08; C02F 1/74; C02F 101/30

(52) U.S. Cl. CPC C02F 1/32; B01J 21/18; B01J 35/33; B01J 35/617; B01J 35/618; B01J 35/633; B01J 35/651; B01J 35/653; B01J 37/0236; B01J 37/06; B01J 37/084; C02F 1/74; B01J 2235/05; B01J 2235/10; B01J 2235/15; B01J 2235/30; C02F 2101/308; C02F 2305/10

(57) ABSTRACT

A method of dye degradation includes contacting a metal-free catalyst with a dye solution in a reaction chamber. The metal-free catalyst includes a carbonized polyimide (PI) material including reacted units of a 4,4′-(hexafluoroisopropylidene) phthalic anhydride and reacted units of a 3,3′-dimethyl-naphthidine. The dye solution includes methylene blue (MB). The method further includes irradiating the reaction chamber with light and degrading dye in the dye solution.

### CROSS REFERENCE TO RELATED APPLICATION

This application claims the benefit of U.S. Provisional Application No. 63/761,099, filed Feb. 20, 2025, which is incorporated herein by reference in its entirety.

### STATEMENT REGARDING PRIOR DISCLOSURE BY THE INVENTORS

Aspects of the present disclosure are described in AlDhawi, Z. A. et al., “Intrinsically microporous polyimide-based metal-free catalysts for round-the-clock photodegradation of organic pollutants” published in Issue 5, Communications Materials, 2024, which is incorporated herein by reference in its entirety.

### STATEMENT OF ACKNOWLEDGEMENT

Support provided by the College of Petroleum Engineering and Geoscience, King Fahd University of Petroleum and Minerals, Saudi Arabia, through Project SF21012 is gratefully acknowledged.

### BACKGROUND

### Technical Field

The present disclosure is directed to a method of dye degradation, more particularly, a method of dye degradation using a metal-free catalyst including a carbonized polyimide material including reacted units of a 4,4′-(hexafluoroisopropylidene) diphthalic anhydride and reacted units of a 3,3′-dimethyl-naphthidine.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Safeguarding access to clean water and maintaining ecological safety remains a challenge in the twenty-first century. Advancement of chemical technology has led to widespread use of synthetic materials in industrial and agricultural production, resulting in continuous release of hard-to-degrade organic pollutants, including toxic dyes. These pollutants, intensified by energy consumption and environmental crises, pose severe threats to sustainable water management [Cai, T. et al., Recent advances in round-the-clock photocatalytic system: Mechanisms, characterization techniques and applications, J. Photochem. Photobiol. C Photochem. Rev., 2019, 39, 58-75]. Traditional physical, chemical, and biological methods cannot effectively remove persistent pollutants and advanced catalysts need to be developed.

Increasing demands in textiles, pharmaceuticals, printing, food, and clothing industries has led to mass production of synthetic dyes, with global annual production reaching approximately 700,000 tons [Oladoye, P. O. et al., Methylene blue dye: Toxicity and potential elimination technology from wastewater, Results Eng., 2022, 16, 100678]. Toxic dyes, such as azo, anthraquinone, and triphenylmethane, resist natural degradation and pose environmental risks. Methylene blue (MB) is a widely used cationic dye known for its environmental persistence, toxicity, carcinogenicity, and mutagenicity [Appavu, B. et al., BiVO₄/N-rGO nano composites as highly efficient visible active photocatalyst for the degradation of dyes and antibiotics in eco system, Ecotoxicol. Environ. Saf, 2018, 151, 118-126]. Currently, the removal of MB from wastewater and aquatic environments has gained great attention and has led to an increase in study during the last decades (FIGS. 1C-1F). FIG. 1C depicts the market size of MB. FIG. 1D depicts application segments of MB utilization. FIG. 1E is a regional analysis for MB utilization. FIG. 1F depicts number of publications per year for MB removal (from Scopus using “methylene blue” and “removal” keywords from 1980 to 2023).

Various techniques have been explored to treat dye-polluted water, including advanced oxidation processes (AOPs), biological treatments, and membrane filtration. Effective dye removal and minimized environmental impact often use a combination of these methods. Numerous strategies have emerged as approaches for addressing dye degradation issues, including ozonation [Zhang, J. et al., Degradation of methylene blue in aqueous solution by ozone-based processes, J. Ind. Eng. Chem., 2009, 15, 185-189], membrane filtration [Nady, N. et al., Dye removal membrane from electrospun nanofibers of blended polybutylenesuccinate and sulphonated expanded polystyrene waste, Sci. Rep., 2023, 13, 1-12], adsorption over heterostructure particles [Song, Y. et al., Heterostructure particles enable omnidispersible in water and oil towards organic dye recycle, Nat. Commun., 2023, 14, 1-12], ion exchange removal, adsorption [Aaddouz, M. et al., Removal of methylene blue from aqueous solution by adsorption onto hydroxyapatite nanoparticles, J. Mol. Struct., 2023, 1288, 339-349], and photocatalytic degradation [Gomaa, H. et al., A hybrid mesoporous CuO@barley straw-derived SiO₂ nanocomposite for adsorption and photocatalytic degradation of methylene blue from real wastewater, Colloids Surfaces A Physicochem. Eng. Asp., 2022, 644, 128811]. Membrane technology is effective, but it suffers from drawbacks like membrane fouling, which needs replacement when clogged or overloaded [Cheng, Z. L. et al., Novel adsorption materials based on graphene oxide/Beta zeolite composite materials and their adsorption performance for rhodamine B, J. Alloys Compd., 2017, 708, 255-263].

Since the discovery of photocatalysis, studies have focused on materials like titanium dioxide (TiO₂), which are active only under ultraviolet light due to their wide band gap from 3.0 to 3.2 electron volts (eV). Despite efforts to improve visible-light absorption, λ>400 nanometers (nm), most modified and doped photocatalysts exhibit low activity, limited visible-light absorption, and poor stability during photocatalysis. Common photocatalysts like TiO₂ and ZnO₂ use continuous light to drive redox reactions, restricting applications, especially at night. When illumination stops, electron-hole pair generation ceases, leading to an immediate loss of catalytic activity. Persistent photocatalysis enables delayed dye degradation by storing photogenerated carriers during illumination and releasing them gradually after light removal, similar to persistent luminescence [Loh, J. Y. Y. et al., Persistent CO₂ photocatalysis for solar fuels in the dark, Nat. Sustain., 2021, 4, 466-473]. Several photocatalysts have been reported for environmental applications, including Mo—TiO₂ [Feng, F. et al., Post illumination activity in a single-phase photocatalyst of Mo-doped TiO₂ nanotube array from its photocatalytic ‘memory,’ ACS Sustain. Chem. Eng., 2018, 6, 6166-6174], Cu₂O/TiO₂ [Liu, L. et al., Synthesis of Cu₂O nanospheres decorated with TiO₂ nanoislands, their enhanced photoactivity and stability under visible light illumination, and their post-illumination catalytic memory, ACS Appl. Mater. Interfaces, 2014, 6, 5629-5639], Cu₂O/SnO₂, and I/TiO₂ [Liu, L. et al., Post-illumination activity of SnO₂ nanoparticle-decorated Cu₂O nanocubes by H₂O₂ production in dark from photocatalytic ‘memory,’ Sci. Rep., 2016, 6, 1-11].

Although most photocatalysts with round-the-clock activity are metal-based semiconductors, there is increasing interest in metal-free alternatives due to their cost-effectiveness and lower toxicity. For instance, a metal-free photocatalyst using graphitic carbon nitride (g-C₃N₄) with carbon nanotubes (CNTs) and graphene (Gr) as a supercapacitor has been used for phenol removal [Zhang, Q. et al., Metal-free photocatalyst with visible-light-driven post-illumination catalytic memory, ACS Appl. Mater. Interfaces, 2017, 9, 21738-21746]. Covalent organic frameworks (COFs) and porous organic polymers are emerging as efficient photocatalysts due to their controllable electron band structure, stability, and simple synthesis using abundant resources [Schukraft, G. E. M. et al., Hypercrosslinked polymers as a photocatalytic platform for visible-light-driven CO₂ photoreduction using H₂O, ChemSusChem, 2021, 14, 1720-1727]. Despite these advances, challenges remain, including limited visible-light absorption, low catalytic efficiency, poor stability, and rapid recombination of photogenerated carriers. Future research should focus on improving light absorption, enhancing carrier separation, and developing durable and eco-friendly catalysts for effective and long-lasting pollutant degradation.

Accordingly, an object of the present disclosure is to provide a method for dye degradation using a metal-free-photocatalyst that may circumvent drawbacks and limitations, such as poor stability, low degradation efficiency, and complex synthesis procedures, of the methods and materials already known in the art.

### SUMMARY

In an exemplary embodiment, a method of dye degradation is described. The method includes contacting a metal-free catalyst with a dye solution in a reaction chamber. The metal-free catalyst includes a carbonized polyimide material including reacted units of a 4,4′-(hexafluoroisopropylidene) diphthalic anhydride and reacted units of a 3,3′-dimethyl-naphthidine. The dye solution includes methylene blue (MB). The method further includes irradiating the reaction chamber with light and degrading dye in the dye solution.

In some embodiments, the metal-free catalyst has a dye degradation efficiency of 60 to 90% based on an initial concentration of dye in the dye solution.

In some embodiments, the metal-free catalyst has a Brunauer-Emmett-Teller (BET) surface area of 500 to 800 square meters per gram (m²/g).

In some embodiments, the metal-free catalyst has a Langmuir surface area of 800 to 1100 m²/g.

In some embodiments, the metal-free catalyst is porous having an average pore diameter of 100 to 700 nanometers (nm).

In some embodiments, the metal-free catalyst is porous having a total pore volume of 0.2 to 0.4 cubic centimeters per gram (cm³/g).

In some embodiments, the method further includes forming the metal-free catalyst by pyrolyzing a film including reacted units of 4,4′-(hexafluoroisopropylidene) diphthalic anhydride and 3,3′-dimethyl-naphthidine at a temperature of 520 to 540° C., to form porous fibers that has a BET surface area of 540 to 550 m²/g, a Langmuir surface area of 835 to 850 m²/g, and a total pore volume of 0.3 to 0.34 cm³/g.

In some embodiments, the method further includes forming the metal-free catalyst by pyrolyzing a film including reacted units of 4,4′-(hexafluoroisopropylidene) diphthalic anhydride and 3,3′-dimethyl-naphthidine at a temperature of 580 to 620° C., to form porous fibers that has a BET surface area of 570 to 580 m²/g, a Langmuir surface area of 800 to 830 m²/g, and a total pore volume of 0.3 to 0.32 cm³/g.

In some embodiments, the method further includes forming the metal-free catalyst by pyrolyzing a film including reacted units of 4,4′-(hexafluoroisopropylidene) diphthalic anhydride and 3,3′-dimethyl-naphthidine at a temperature of 780 to 820° C., to form porous fibers that has a BET surface area of 590 to 600 m²/g, a Langmuir surface area of 825 to 835 m²/g, and a total pore volume of 0.28 to 0.3 cm³/g.

In some embodiments, the method further includes forming the metal-free catalyst by pyrolyzing a film including reacted units of 4,4′-(hexafluoroisopropylidene) diphthalic anhydride and 3,3′-dimethyl-naphthidine at a temperature of 980 to 1020° C., to form porous fibers that has a BET surface area of 720 to 740 m²/g, a Langmuir surface area of 1040 to 1050 m²/g, and a total pore volume of 0.35 to 0.37 cm³/g.

In some embodiments, the metal-free catalyst has a bandgap value of 2.5 to 3.5 electron volts (eV).

In some embodiments, the metal-free catalyst has an adsorption capacity (Q_{ads}) of 3 to 10 mg/g.

In some embodiments, the metal-free catalyst has a degradation rate of MB of 0.001 to 0.012 per minute (min⁻¹).

In some embodiments, the method includes contacting the metal-free catalyst with the dye solution in the reaction chamber occurs in the absence of light for 1 to 150 minutes (min).

In some embodiments, the method includes irradiating the reaction chamber with light for 5 to 1200 min.

In another embodiment, a process of making the metal-free catalyst is described. The process of making the metal-free catalyst includes heating 4,4′-(hexafluoroisopropylidene) diphthalic anhydride and 3,3′-dimethyl-naphthidine in m-cresol (C₇H₈O) with an isoquinoline (C₉H₇N) under nitrogen (N₂) to form a polyimide (PI) solution. The process further includes adding an alcohol to the polyimide solution to form a precipitate, washing and drying the precipitate at a temperature of 100 to 200° C. for 20 to 28 hours (h) to form a polymer, and carbonizing the polymer at a temperature of 500 to 1200° C. for 0.5 to 2 h to form the metal-free catalyst.

In some embodiments, the polymer has a number-average molecular weight (M_{w}) of 66,000 to 70,000 grams per mole (g/mol).

In some embodiments, the polymer has a molecular weight (M_{w}) of 82,000 to 86,000 g/mol.

In some embodiments, the method includes a signal of carbon intensity for the porous fibers that is 3 to 5 times greater compared to a signal of carbon intensity for the film including reacted units of 4,4′-(hexafluoroisopropylidene) diphthalic anhydride and 3,3′-dimethyl-naphthidine that has not been pyrolyzed based on energy dispersive X-ray analysis (EDX).

In some embodiments, the method further includes forming the metal-free catalyst by thermally annealing a film including reacted units of 4,4′-(hexafluoroisopropylidene) diphthalic anhydride and 3,3′-dimethyl-naphthidine at a temperature of 500 to 1200° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart depicting a method of dye degradation, according to certain embodiments.

FIG. 1B is a schematic flow chart depicting a method of forming a metal-free catalyst, according to certain embodiments.

FIG. 1C is a schematic depicting market size of methylene blue (MB), according to certain embodiments.

FIG. 1D is a schematic depicting application segments of MB utilization, according to certain embodiments.

FIG. 1E is a schematic depicting regional analysis for MB utilization, according to certain embodiments.

FIG. 1F is a schematic depicting the number of publications per year for MB removal (from Scopus using “methylene blue” and “removal” keywords from 1980 to 2023), according to certain embodiments.

FIG. 2A is a schematic representation of a synthesis of 4,4′-(hexafluoroisopropylidene) diphthalic anhydride (6FDA) and 3,3′-dimethyl-naphthidine (DMN) polymer (6FDA-DMN), according to certain embodiments.

FIG. 2B is a three-dimensional (3D) structure of 6FDA-DMN and its carbonized version, according to certain embodiments.

FIG. 2C depicts structures of porous polyimide 6FDA and 2,4,6-trimethylbenzene-1,3-diamine (6FDA-TrMPD) and nonporous polyimide 6FDA and m-phenylenediamine (mPDA) (6FDA-mPDA), according to certain embodiments.

FIG. 3A is a proton nuclear magnetic resonance (¹H NMR) spectrum of 6FDA-DMN (P0) in deuterated chloroform (CDCl₃), according to certain embodiments.

FIG. 3B depicts a fluorine-19 (¹⁹F) NMR spectrum of 6FDA-DMN (P0) in CDCl₃, according to certain embodiments.

FIG. 4A is a Fourier-transform infrared (FTIR) spectra of 6FDA-DMN-based catalysts, according to certain embodiments.

FIG. 4B depicts thermogravimetric analysis (TGA) curves of 6FDA-DMN-based catalysts, according to certain embodiments.

FIG. 4C depicts energy-dispersive X-ray (EDX) spectra of 6FDA-DMN-based catalysts, according to certain embodiments.

FIG. 4D depicts EDX mapping of carbon (C) for 6FDA-DMN-based catalysts, according to certain embodiments.

FIG. 4E depicts EDX mapping of nitrogen (N) for 6FDA-DMN-based catalysts, according to certain embodiments.

FIG. 4F depicts EDX mapping of oxygen (O) for 6FDA-DMN-based catalysts, according to certain embodiments.

FIG. 4G depicts EDX mapping of fluorine (F) for 6FDA-DMN-based catalysts, according to certain embodiments.

FIG. 4H depicts wide-angle X-ray Diffraction (WXRD) patterns of 6FDA-DMN-based catalysts, according to certain embodiments.

FIG. 4I depicts nitrogen (N₂) adsorption isotherms of 6FDA-DMN-based catalysts, according to certain embodiments.

FIG. 4J depicts pore size distribution of 6FDA-DMN-based catalysts, according to certain embodiments.

FIG. 5A is a scanning electron microscopy (SEM) image of a 6FDA-DMN-based catalyst pyrolyzed at 530 degrees Celsius (° C.) (P1), according to certain embodiments.

FIG. 5B depicts pore size distribution for P1, according to certain embodiments.

FIG. 5C is an SEM image of a 6FDA-DMN-based catalyst pyrolyzed at 600° C. (P2), according to certain embodiments.

FIG. 5D depicts pore size distribution of P2, according to certain embodiments.

FIG. 5E is an SEM image of a 6FDA-DMN-based catalyst pyrolyzed at 800° C. (P3), according to certain embodiments.

FIG. 5F depicts pore size distribution of P3, according to certain embodiments.

FIG. 5G is an SEM image of a 6FDA-DMN-based catalyst pyrolyzed at 1000° C. (P4), according to certain embodiments.

FIG. 5H depicts pore size distribution of P4, according to certain embodiments.

FIG. 6A depicts a Tauc plot showing an energy band gap of 6FDA-DMN-based catalysts, P0 and P1, according to certain embodiments.

FIG. 6B depicts a Tauc plot showing an energy band gap of 6FDA-DMN-based catalysts, P2, P3, and P4, according to certain embodiments.

FIG. 7A depicts photoluminescence (PL) spectra of 6FDA-DMN-based catalysts, according to certain embodiments.

FIG. 7B depicts time-resolved photoluminescence (TRPL) decay spectra for P0, P1, P2, P3, and P4, according to certain embodiments.

FIG. 7C is a schematic representation of an excitation and charge separation state of P0, depicting influence of an acceptor-donor structure in the polymer backbone, according to certain embodiments.

FIG. 7D illustrates the charge recombination rate of pristine polymers to carbonized structures, according to certain embodiments.

FIG. 8A depicts adsorption and photodegradation of MB with 6FDA-DMN-based catalysts, according to certain embodiments.

FIG. 8B depicts pseudo-first-order kinetic plots for MB photodegradation with 6FDA-DMN-based catalysts, according to certain embodiments.

FIG. 8C depicts continuous photodegradation of MB in the dark using P0, according to certain embodiments.

FIG. 8D depicts continuous photodegradation of MB in the dark using P1, according to certain embodiments.

FIG. 8E depicts pre-irradiation effects of P0 in the solid state on MB photodegradation in the dark, according to certain embodiments.

FIG. 8F depicts pre-irradiation effects of P1 in the solid state on MB photodegradation in the dark, according to certain embodiments.

FIG. 9 depicts color change of MB during adsorption, degradation, and light-off photodegradation using P0, according to certain embodiments.

FIG. 10 depicts color change of MB during adsorption, degradation, and light-off photodegradation using P1, according to certain embodiments.

FIG. 11 depicts color change of MB during adsorption, degradation, and light-off photodegradation using P2, according to certain embodiments.

FIG. 12 depicts color change of MB during adsorption, degradation, and light-off photodegradation using P3, according to certain embodiments.

FIG. 13 depicts color change of MB during adsorption, degradation, and light-off photodegradation using P4, according to certain embodiments.

FIG. 14A is a Nyquist plot of P0, according to certain embodiments.

FIG. 14B is a Nyquist plot of P1, according to certain embodiments.

FIG. 14C is a Nyquist plot of P2, according to certain embodiments.

FIG. 14D depicts an equivalent circuit, according to certain embodiments.

FIG. 15 depicts porosity and monomer type effects on photodegradation of MB, according to certain embodiments.

FIG. 16 depicts apparent quantum yield as a function of incident light wavelength during MB degradation over P1, with error bars representing data from three sets of experiments, according to certain embodiments.

FIG. 17 depicts an ultraviolet (UV) spectrum of degradation of methylene blue in the presence and absence of light, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals will be used to designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

When amounts, concentrations, dimensions, and other parameters are expressed in the form of a range, a preferable range, an upper limit value, a lower limit value, or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein, the term “amount” refers to the level or concentration of one or more reactants, catalysts, or materials present in a reaction mixture.

As used herein, the term “fibers” refers to a material that is longer than it is wide. Fibers may be used in the manufacture of other materials, such as a membrane.

As used herein, the term “membrane” refers to a porous structure that is capable of separating components of a homogeneous or heterogeneous fluid. In particular, “pores” in the sense of the present disclosure indicate voids allowing fluid communication between different sides of the structure. More particular, in use when a homogeneous or heterogeneous fluid is passed through the membrane, some components of the fluid can pass through the pores of the membrane into a “permeate stream,” some components of the fluid can be retained by the membrane and can thus accumulate in a “retentate,” and/or some components of the fluid can be rejected by the membrane into a “rejection stream.” Membranes can be of various thicknesses, with homogeneous or heterogeneous structures. Membranes can be in the form of flat sheets or bundles of hollow fibers. Membranes can also be in various configurations, including, but not limited to, spiral wound, tubular, hollow fiber, a combination thereof, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “porous” refers to a material that contains holes, spaces, or voids (pores) within its structure, allowing the passage of fluids or gases through it.

As used herein, the term “average pore diameter” refers to the mean size of the pores in a porous material, typically measured in nanometers (nm) or micrometers (mm), and indicates spacing between pore walls.

As used herein, the term “total pore volume” refers to the total volume of all pores within a porous material, typically measured in cubic centimeters per gram (cm³/g), and represents the material's capacity to hold fluids or gases.

As used herein, the term “absorption” refers to a process by which one substance takes in or soaks up another, such as a material absorbing light, heat, or liquid.

As used herein, the term “adsorption” refers to the adhesion of atoms, ions, or molecules from a gas, liquid, or dissolved solid to a surface. The process creates a film of an adsorbate (i.e., organic dyes, heavy metal ions, and the like) on the surface of an adsorbent. This is not the same as absorption, when a liquid dissolves or permeates a solid. Absorption utilizes the entire volume of the substance, and adsorption is confined to the surface of the substance. Both of these processes are referred to as sorption, whereas desorption is the opposite.

As used herein, the term “adsorption capacity” refers to the maximum amount of a substance that can be adsorbed onto a surface or material, typically measured in units like milligrams of substance per gram of material, indicating the material's ability to attract and hold particles or molecules.

As used herein, the term “catalyst” refers to a substance that speeds up a chemical reaction without being consumed or permanently changed in the process.

A weight percent of a component, unless specifically stated to the contrary, is based on the total weight of the formulation or composition in which the component is included. For example, if a particular element or component in a composition or article is said to have 5 percent by weight (wt. %), it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, isotopes of carbon include ¹¹C and ¹⁴C, isotopes of nitrogen include ¹⁴N and ¹⁵N. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed toward metal-free catalysts derived from intrinsically microporous polyimide for effective photocatalytic degradation of methylene blue (MB). The catalysts showed successful degradation of the dye (MB) under sunlight, with both pristine and thermally annealed samples, exhibiting excellent light storage properties for continuous degradation in darkness. Pre-irradiation enhanced degradation efficiency by around 40%. The present disclosure highlights monomer units and porosity properties for enhancing photocatalytic performance of microporous polymers in continuous water purification.

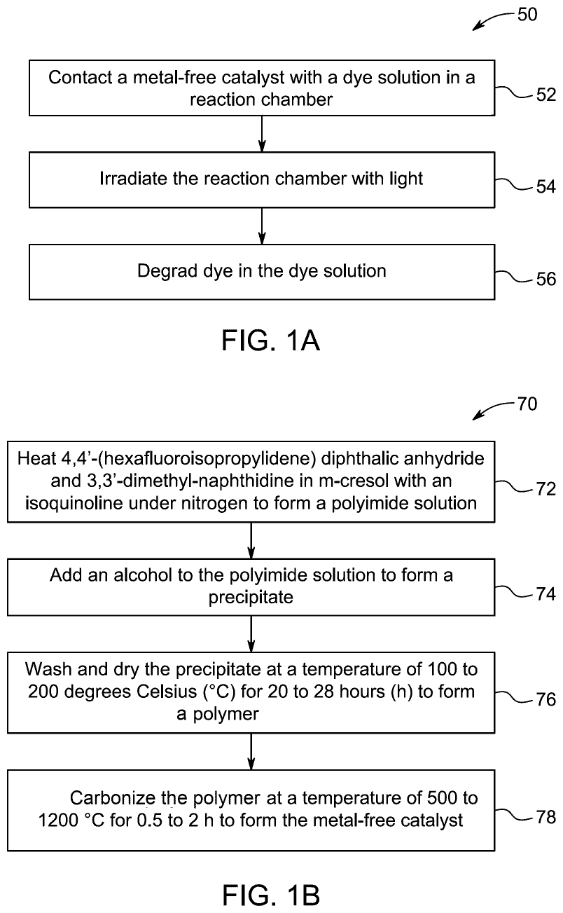

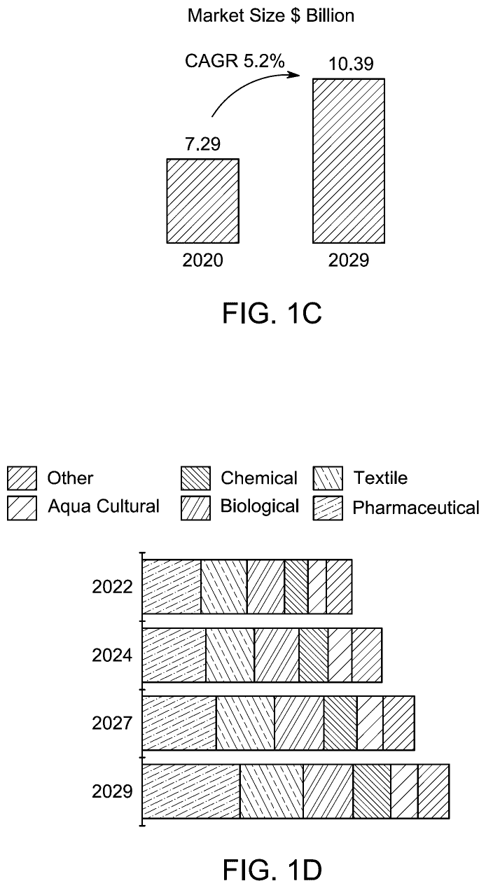

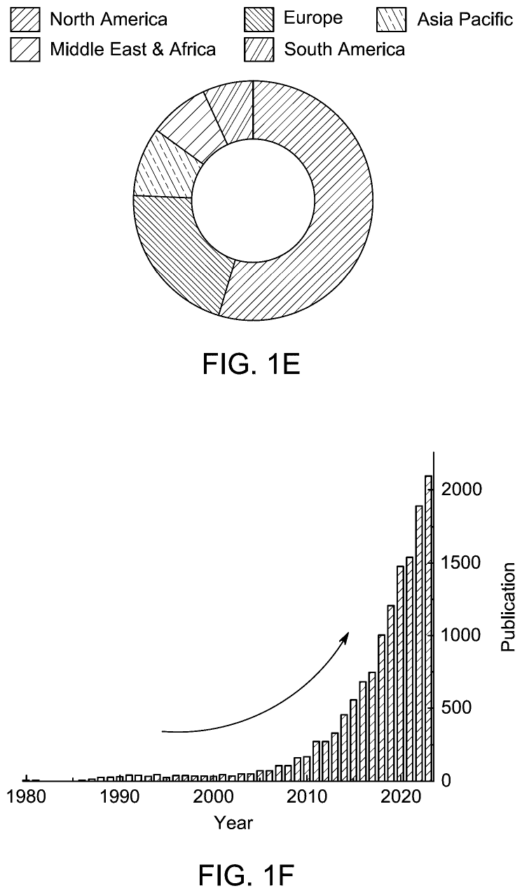

FIG. 1A illustrates a schematic flow chart of a method 50 of dye degradation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting a metal-free catalyst with a dye solution in a reaction chamber. As used herein, the term “metal-free catalyst” refers to a catalyst that does not contain metal elements and instead utilizes non-metallic materials, such as carbon-based compounds or organic molecules, to accelerate chemical reactions. These catalysts offer advantages such as lower costs, reduced environmental impact, avoidance of metal contamination in a solution, and avoidance of metal leakage and/or release from the catalyst. The metal-free catalyst includes a carbonized polyimide material including reacted units of a 4,4′-(hexafluoroisopropylidene) diphthalic anhydride and reacted units of a 3,3′-dimethyl-naphthidine. As used herein, “polyimide” refers to a polymer containing imide groups. An imide is a functional group consisting of two acyl groups bound to nitrogen. In some embodiments, the reacted units of a 4,4′-(hexafluoroisopropylidene) diphthalic anhydride and the reacted units of a 3,3′-dimethyl-naphthidine are in an alternating pattern in the carbonized polyimide material. In alternative methods, the metal-free catalyst may include any other polyimide and/or polymer known in the art.

In some embodiments, the metal-free catalyst is porous. A porous metal-free catalyst is one that forms a porous bulk solid. Pores may be micropores, mesopores, macropores, and/or a combination thereof. The pores exist in the bulk material, but not necessarily in the molecular structure of the metal-free catalyst. The term “microporous” means the metal-free catalyst has pores with an average pore width (i.e., diameter) of less than 2 nm. The term “mesoporous” means the pores of the metal-free catalyst have an average pore width of 2-50 nm. The term “macroporous” means the pores of the metal-free catalyst have an average pore width larger than 50 nm. Pore size may be determined by methods including, but not limited to, gas adsorption (e.g., N₂ adsorption), mercury intrusion porosimetry, and imaging techniques such as scanning electron microscopy (SEM) and X-ray computed tomography (XRCT).

In some embodiments, the metal-free catalyst is porous having an average pore diameter of 100-700 nm, preferably 150-650 nm, preferably 200-600 nm, preferably 250-550 nm, preferably 300-500 nm, and preferably 350-450 nm. In some embodiments, the metal-free catalyst is porous having a total pore volume of 0.2-0.4 cm³/g, preferably 0.21-0.39 cm³/g, preferably 0.22-0.38 cm³/g, preferably 0.23-0.37 cm³/g, preferably 0.24-0.36 cm³/g, preferably 0.25-0.35 cm³/g, preferably 0.26-0.34 cm³/g, preferably 0.27-0.33 cm³/g, preferably 0.28-0.32 cm³/g, and preferably 0.29-0.31 cm³/g. In other embodiments, the metal-free catalyst may include any porous material known in the art.

In some embodiments, the metal-free catalyst has a Brunauer-Emmett-Teller (BET) surface area of 500-800 square meters per gram (m²/g), preferably 510-790 m²/g, preferably 520-780 m²/g, preferably 530-770 m²/g, preferably 540-760 m²/g, preferably 550-750 m²/g, preferably 560-740 m²/g, preferably 570-730 m²/g, preferably 580-720 m²/g, preferably 590-710 m²/g, preferably 600-700 m²/g, preferably 610-690 m²/g, preferably 620-680 m²/g, preferably 630-670 m²/g, and preferably 640-660 m²/g. The BET hypothesis is the foundation for an analysis method for determining the specific surface area of a material. It explains the physical adsorption of gas molecules on a solid surface. Specific surface area is a property of solids, which is the total surface area of a material per unit of mass, solid or bulk volume, or cross-sectional area. In some embodiments, pore diameter, pore volume, and BET surface area are measured by gas adsorption analysis, preferably N₂ adsorption analysis (e.g., N₂ adsorption isotherms).

In some embodiments, the metal-free catalyst has a Langmuir surface area of 800-1100 m²/g, preferably 810-1090 m²/g, preferably 820-1080 m²/g, preferably 830-1070 m²/g, preferably 840-1060 m²/g, preferably 850-1050 m²/g, preferably 860-1040 m²/g, preferably 870-1030 m²/g, preferably 880-1020 m²/g, preferably 890-1010 m²/g, preferably 900-1000 m²/g, preferably 910-990 m²/g, preferably 920-980 m²/g, preferably 930-970 m²/g, and preferably 940-960 m²/g.

A carbonized polyimide material is a type of material made from polyimide polymers that have been heated to high temperatures in an inert atmosphere to convert the material into carbon. The process enhances thermal stability, mechanical strength, and chemical resistance of the material that is carbonized. The carbonized polyimide material may be a film, a powder, a fiber, a combination thereof, and the like. In one embodiment, the carbonized polyimide material comprises carbonized polyimide fibers. In some embodiments, the carbonized polyimide fibers form a membrane. In some embodiments, the carbonized polyimide fibers form a carbonized polyimide membrane. In some embodiments, carbonized polyurethane fibers, graphene oxide fibers, activated carbon fibers, carbon nanotube fibers, porous carbon fibers, and/or polyimide-derived carbon fibers may also be used in combination with or as an alternative to the carbonized polyimide fibers.

A dye is a colored substance that chemically binds to a material it may be intended to color. Generally, dye is applied to a solution, typically an aqueous solution. Examples of dyes include, but are not limited to, acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIAsH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red 0, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, MB, methylene green, new MB, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, Indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B, and the like. In some embodiments, the dye may include, but is not limited to, Congo red, imidacloprid, malachite green, methylene blue, a combination thereof, and the like. In a preferred embodiment, the dye solution includes methylene blue (MB).

A reaction chamber is a sealed or controlled environment used to facilitate and contain chemical reactions, often equipped with mechanisms to control temperature, pressure, and other variables to control reaction conditions. Examples of a reaction chamber include, but are not limited to, a laboratory reaction chamber, an industrial reaction chamber, a bioreactor, a combustion chamber, a plasma reaction chamber, a capped vial, and the like. In some embodiments, contacting the metal-free catalyst with the dye solution in the reaction chamber occurs in the absence of light for 1-150 minutes (min), preferably 10-140 min, preferably 20-130 min, preferably 30-120 min, preferably 40-110 min, preferably 50-100 min, preferably 60-90 min, and preferably 70-80 min. The reaction may be conducted in the absence of light to isolate and evaluate the catalytic activity of the metal-free catalyst, ensuring that the observed effects are solely attributed to the catalyst's intrinsic properties and not influenced by photochemical reactions. This condition allows for a controlled assessment of the catalyst's performance under non-illuminated conditions, particularly in applications where light-driven processes are not intended or desired. The absence of light ensures the catalyst's inherent chemical interactions with the dye solution are driving the reaction.

At step 54, the method 50 includes irradiating the reaction chamber with light. In some embodiments, irradiating the reaction chamber with light occurs for 5-1200 min, preferably 20-1185 min, preferably 40-1165 min, preferably 60-1145 min, preferably 80-1125 min, preferably 100-1105 min, preferably 120-1085 min, preferably 140-1065 min, preferably 160-1045 min, preferably 180-1025 min, preferably 200-1005 min, preferably 250-955 min, preferably 300-905 min, preferably 350-855 min, preferably 400-805 min, preferably 450-755 min, preferably 500-705 min, preferably 550-655 min, and preferably 600-605 min. Examples of light sources for irradiating the reaction chamber may include, but are not limited to, UV lamp, xenon arc lamp, mercury vapor lamp, halogen lamp, LED light source, fluorescent lamp, sunlight, laser light source, high-pressure sodium lamp, metal halide lamp, a combination thereof, and the like. In a preferred embodiment, the light used is visible light and the light source is LED light.

The purpose of irradiating the reaction chamber with light may be to initiate or enhance photocatalytic activity of the metal-free catalyst, promoting the degradation or transformation of the dye solution. Exposure to light may activate the catalyst and facilitate the photocatalytic process, which may result in increased efficiency or a faster reaction rate. The specific duration of light exposure may promote increased activation of the catalyst for catalytic effects, enabling effective dye degradation and/or other outcomes.

At step 56, the method 50 includes degrading dye in the dye solution. Degrading dye in the dye solution involves breaking down or removing dye molecules from the solution, typically using methods like photocatalysis, chemical oxidation/reduction, biological degradation, and/or thermal degradation. Photocatalysis, activated by light, uses catalysts to break down dyes into less harmful substances. Chemical and biological methods involve using agents or microorganisms to degrade the dye. Effective dye degradation is used for environmental protection, ensuring cleaner water and reducing toxic waste in industries such as textiles and wastewater treatment.

In some embodiments, the metal-free catalyst has a dye degradation efficiency of 60-90%, preferably 61-89%, preferably 62-88%, preferably 63-87%, preferably 64-86%, preferably 65-85%, preferably 66-84%, preferably 67-83%, preferably 68-82%, preferably 69-81%, preferably 70-80%, preferably 71-79%, preferably 72-78%, preferably 73-77%, and preferably 74-76% based on an initial concentration of dye in the dye solution.

In some embodiments, the method 50 further includes forming the metal-free catalyst by pyrolyzing a film including reacted units of 4,4′-(hexafluoroisopropylidene) diphthalic anhydride and 3,3′-dimethyl-naphthidine at a temperature of 520 to 540 degrees Celsius (° C.), preferably 525 to 535° C., and more preferably about 530° C., to form porous fibers that has a BET surface area of 540-550 m²/g, preferably 541-549 m²/g, preferably 542-548 m²/g, preferably 543-547 m²/g, more preferably 544-546 m²/g, and yet more preferably about 545 m²/g, a Langmuir surface area of 835-850 m²/g, preferably 836-849 m²/g, preferably 837-848 m²/g, preferably 838-847 m²/g, preferably 839-846 m²/g, preferably 840-845 m²/g, preferably 841-844 m²/g, more preferably 842-843 m²/g and yet more preferably about 842 m²/g, and a total pore volume of 0.3-0.34 cm³/g, preferably 0.31-0.33 cm³/g, and more preferably about 0.32 cm³/g.

In some embodiments, the method 50 further includes forming the metal-free catalyst by pyrolyzing a film including reacted units of 4,4′-(hexafluoroisopropylidene) diphthalic anhydride and 3,3′-dimethyl-naphthidine at a temperature of 580 to 620° C., preferably 590 to 610° C., and more preferably about 600° C., to form porous fibers that has a BET surface area of 570 to 580 m²/g, preferably 571 to 578, more preferably 572 to 576 m²/g, and yet more preferably about 574 m²/g, a Langmuir surface area of 800-830 m²/g, preferably 801-828 m²/g, preferably 802-826 m²/g, preferably 803-824 m²/g, preferably 804-822 m²/g, preferably 805-820 m²/g, preferably 806-819 m²/g, preferably 807-818 m²/g, preferably 808-817 m²/g, preferably 809-816 m²/g, preferably 810-815 m²/g, more preferably 811-813 m²/g, and yet more preferably about 812 m²/g, and a total pore volume of 0.3-0.32 cm³/g, preferably 0.305-0.315 cm³/g, and more preferably about 0.31 cm³/g.

In some embodiments, the method 50 further includes forming the metal-free catalyst by pyrolyzing a film including reacted units of 4,4′-(hexafluoroisopropylidene) diphthalic anhydride and 3,3′-dimethyl-naphthidine at a temperature of 780 to 820° C., preferably 790 to 810° C., and more preferably about 800° C., to form porous fibers that has a BET surface area of 590-600 m²/g, preferably 591-599 m²/g, preferably 592-598 m²/g, preferably 593-597 m²/g, more preferably 594-596 m²/g, and yet more preferably about 596 m²/g, a Langmuir surface area of 825-835 m²/g, preferably 826-834 m²/g, preferably 827-833 m²/g, preferably 828-832 m²/g, more preferably 829-831 m²/g, and yet more preferably about 830 m²/g, and a total pore volume of 0.28-0.3 cm³/g, preferably 0.285-0.295 cm³/g, and more preferably about 0.29 cm³/g.

In some embodiments, the method 50 further includes forming the metal-free catalyst by pyrolyzing a film including reacted units of 4,4′-(hexafluoroisopropylidene) diphthalic anhydride and 3,3′-dimethyl-naphthidine at a temperature of 980 to 1020° C., preferably 990 to 1010° C., and more preferably 1000° C., to form porous fibers that has a BET surface area of 720-740 m²/g, preferably 721-739 m²/g, preferably 722-738 m²/g, preferably 723-737 m²/g, preferably 724-736 m²/g, preferably 725-735 m²/g, preferably 726-734 m²/g, preferably 727-733 m²/g, preferably 728-732 m²/g, more preferably 729-731 m²/g, and yet more preferably about 729 m²/g, a Langmuir surface area of 1040-1050 m²/g, preferably 1041-1049 m²/g, preferably 1042-1048 m²/g, preferably 1043-1047 m²/g, more preferably 1044-1046 m²/g, and yet more preferably about 1044 m²/g, and a total pore volume of 0.35 to 0.37 cm³/g, preferably 0.355 to 0.365 cm³/g, and more preferably about 0.36 cm³/g.

In some embodiments, the metal-free catalyst has a bandgap value of 2.5 to 3.5 electron volts (eV), preferably 2.6 to 3.4 eV, preferably 2.7 to 3.3 eV, preferably 2.8 to 3.2 eV, preferably 2.9 to 3.1 eV, and preferably about 3.0 eV In some embodiments, the metal-free catalyst has an adsorption capacity (Q_{ads}) of 3-10 milligrams of dye per gram of the metal-free catalyst (mg/g), preferably 4-9 mg/g, preferably 5-8 mg/g, and preferably 6-7 mg/g. In some embodiments, the metal-free catalyst has a Q_{ads} of about 8.7 mg/g. In other embodiments, the metal-free catalyst has a Q_{ads} of about 9.7 mg/g. In some other embodiments, the metal-free catalyst has a Q_{ads} of about 5.47 mg/g. In yet another embodiment, the metal-free catalyst has a Q_{ads} of about 6.12 mg/g. In some embodiments, the metal-free catalyst has a Q_{ads} of about 3.87 mg/g. In some embodiments, the metal-free catalyst has a degradation rate of MB of 0.001-0.012 per minute (min⁻¹), preferably 0.002-0.011 min⁻¹, preferably 0.003-0.010 min⁻¹, preferably 0.004-0.009 min⁻¹, preferably 0.005-0.008 min⁻¹, and preferably 0.006-0.007 min⁻¹.

FIG. 1B illustrates a schematic flow chart of a process 70 of making the metal-free catalyst. The order in which the process 70 is described is not intended to be construed as a limitation, and any number of the described method steps can be combined in any order to implement the process 70. Additionally, individual steps may be removed or skipped from the process 70 without departing from the spirit and scope of the present disclosure.

At step 72, the process 70 includes heating 4,4′-(hexafluoroisopropylidene) diphthalic anhydride and 3,3′-dimethyl-naphthidine in m-cresol with an isoquinoline under nitrogen to form a polyimide solution. In some embodiments, the heating can be performed by using heating appliances such as ovens, microwaves, autoclaves, hot plates, heating mantles and tapes, oil baths, salt baths, sand baths, air baths, hot-tube furnaces, hot-air guns, a combination thereof, and the like.

At step 74, the process 70 includes adding an alcohol to the polyimide solution to form a precipitate. The alcohol is added to the polyimide solution, causing the polyimide to precipitate out of the solution. Examples of the alcohol may include, but are not limited to, methanol, ethanol, isopropanol (IPA), butanol, a combination thereof, and the like. In a preferred embodiment, the alcohol is methanol.

At step 76, the process 70 includes washing and drying the precipitate at a temperature of 100 to 200° C., preferably 120 to 180° C., more preferably 140 to 160° C., and yet more preferably about 150° C. for 20 to 28 hours (h), preferably 22 to 26 h, and more preferably about 24 h to form a polymer. The washing may be done by using a solvent like water, alcohol, or a mixture thereof. The water may be tap water, distilled water, bi-distilled water, deionized water, deionized distilled water, reverse osmosis water, and/or some other water. In some embodiments, the drying can be performed by using heating appliances such as ovens, microwaves, autoclaves, hot plates, heating mantles and tapes, oil baths, salt baths, sand baths, air baths, hot-tube furnaces, hot-air guns, a combination thereof, and the like. In a preferred embodiment, the precipitate is dried in a vacuum oven.

At step 78, the process 70 includes carbonizing the polymer at a temperature of 500-1200° C., preferably 600-1100° C., preferably 700-1000° C., preferably 800-900° C., preferably about 530° C., preferably about 600° C., preferably about 800° C., and preferably about 1000° C. for 0.5-2 h, and preferably 1-1.5 h to form the metal-free catalyst. Carbonizing the polymer refers to the process of heating the polymer at high temperatures in the absence of oxygen, causing them to undergo thermal decomposition. This results in the conversion of the polymer into a carbon-rich material, which forms the metal-free catalyst. In some embodiments, the polymer has a number-average molecular weight (Mₙ) of 66,000 to 70,000 grams per mole (g/mol), preferably 67,000 to 69,000 g/mol, and more preferably about 68,000 g/mol. In some embodiments, the polymer has a molecular weight (M_{w}) of 82,000 to 86,000 g/mol, preferably 83,000 to 85,000 g/mol, and more preferably about 84,000 g/mol.

In some embodiments, the process 70 further includes forming the metal-free catalyst by thermally annealing a film including reacted units of 4,4′-(hexafluoroisopropylidene) diphthalic anhydride and 3,3′-dimethyl-naphthidine at a temperature of 500-1200° C., preferably 600-1100° C., preferably 700-1000° C., and preferably 800-900° C. This high-temperature treatment causes the film to undergo thermal decomposition, resulting in a carbonized structure that forms the metal-free catalyst.

In some embodiments, a signal of carbon intensity for the porous fibers is 3 to 5, preferably 3.5 to 4.5, and preferably about 4 times greater compared to a signal of carbon intensity for the film including reacted units of 4,4′-(hexafluoroisopropylidene) diphthalic anhydride and 3,3′-dimethyl-naphthidine that has not been pyrolyzed based on energy dispersive X-ray (EDX) analysis. This increase in carbon intensity indicates the successful formation of a highly carbonized structure in the annealed fibers, further enhancing its properties for use as a catalyst.

### EXAMPLES

The following examples describe and demonstrate a method of dye degradation using metal-free catalysts and process of making thereof. The examples are provided solely for illustration and are not to be construed as limitations of the present disclosure, as many variations thereof are possible without departing from the spirit and scope of the present disclosure.

### Example 1: Materials and Methods

The chemical reagents used in the present disclosure were all analytical grade. 4,4′-(Hexafluoroisopropylidene) diphthalic anhydride (6FDA, 99%), 3,3′-dimethyl-naphthidine (DMN, 98%), m-phenylenediamine (mPDA, 99%), 2,4,6-trimethylbenzene-1,3-diamine (TrMPD, 98%), isoquinoline (97%), m-cresol (99%), chloroform (≥99.5%), N-methyl-2-pyrrolidone (NMP, 99.9%), methanol (≥99.9%) and methylene blue (MB, 99%) were all purchased from Merck (KGaA, Darmstadt, Germany) and used without further purification.

### Example 2: Synthesis of 6FDA-DMN

6FDA-DMN was synthesized by slightly modifying a previously reported method, which includes polycondensation reaction of dianhydride (6FDA) and diamine (DMN) at a temperature of 200 degrees Celsius (° C.) [Nimkar, A. et al., Polyimide compounds for post-lithium energy storage applications, Angew. Chemie—Int. Ed., 2023, 62, e202306904, which is incorporated herein by reference in its entirety]. The reaction was initiated by combining equimolar amounts of 4,4′-(hexafluoroisopropylidene) diphthalic anhydride (6FDA) and 3,3′-dimethyl-naphthidine (DMN) in m-cresol, along with 0.1 millimeter (mL) of isoquinoline as a catalyst, in a Schlenk tube under a nitrogen atmosphere. The mixture was first heated to 100° C., followed by a gradual increase to 200° C. to facilitate complete imidization and the full conversion of poly(amic) acid to polyimide. The resulting solution was then precipitated in methanol (CH₃OH), washed three times, and dried in a vacuum oven at 150° C. for 24 hours (h), yielding polymer fibers. Fourier-transform infrared (FTIR) spectroscopy of the polymer powder revealed characteristic absorption peaks at 1789 wavenumbers (cm⁻¹), 1724 cm⁻¹, and 1350 cm⁻¹, corresponding to an asymmetric C═O stretch, a symmetric C═O stretch, and a C—N stretch, respectively. The polymer exhibited a number-average molecular weight (M_{w}) of 68,000 g/mol, a molecular weight (M_{w}) of 84,000 g/mol, and a polydispersity index of 1.23. The 5% decomposition temperature (T_{d,5 %}) was determined to be 525° C.

### Example 3: Synthesis of 6FDA-DMN-Based Catalysts

The polymer fibers were placed in an alumina crucible and transferred to a Carbolite furnace. Carbonization of the polymer fibers was performed at temperatures ranging from 530° C. to 1000° C., with a heating rate of 2° C. per minute (° C. min⁻¹), followed by an isothermal treatment for one hour. The furnace was then allowed to cool naturally to a room temperature of 22° C. The resulting carbonized samples were collected and stored in a desiccator to prevent moisture absorption.

### Example 4: Characterization

Fourier-transform infrared (FTIR) spectra of all samples were recorded on Bruker INVENIO Series FTIR spectrometer with 63 scans at a resolution of 4 cm⁻¹ in the range of 400-4000 cm⁻¹. Wide-angle X-ray diffraction (WXRD) patterns were collected from PanAnalytical diffractometer model Empyrean Alpha1 (Cu Kα radiation with a wavelength of 0.154 nanometer (nm) at 40 kilovolts (kV) and 20 milli amperes (mA) with a scan speed of 0.014 degrees per second (s⁻¹) in 2θ range of 4-70°. The d-spacing was estimated by Bragg's formula, as shown below:

nλ=2d sin θ

Thermogravimetric analysis (TGA) was performed on a PerkinElmer TGA 8000 instrument from 30 to 800° C. at a heating rate of 10° C. min⁻¹ under a nitrogen atmosphere with a flow rate of 20 milliliters per minute (mL min⁻¹). The Brunauer, Emmett and Teller (BET) surface area, pore size distribution, and pore volume of the catalysts were analyzed using nitrogen adsorption isotherms measured at −196° C., which were obtained using a Micromeritics ASAP 2020 adsorption analyzer. The number-average molecular weight (Mₙ), molecular weight (M_{w}), and polydispersity index (PDI) of 6FDA-DMN was obtained from gel permeation chromatography using an Agilent 1200 system with DMF and polystyrene. The microscopic morphologies of the prepared catalysts were measured using the ZEISS Gemini SEM 460 series instrument coupled with EDS. The samples were coated with a thin layer of gold/palladium (80/20%) before being loaded to the system. The images were taken at 50 picoamperes (pA) probe current and 5 kilovolts (kV) acceleration voltage using the SE2 detector. The optical properties (bandgap) of the obtained polymers were done using a Cary 7000 Universal Measurement Spectrophotometer (UMS) from Agilent. Frequency-dependent impedance measurements were made with the use of an impedance analyzer (PalmSens). The experiments were performed at room temperature by scanning the frequency between 1 hertz (Hz) and 1 megahertz (MHz) while applying a voltage of 5 millivolts root mean square (mVRms). The samples were employed as thin films with dimensions of 13×10×2 mm. The samples were irradiated under light at a distance of 15 centimeters (cm) for 6 h. Subsequently, they were sandwiched between two glass slides treated with conductive fluorine-doped tin oxide (FTO) electrodes.

### Example 5: Photocatalytic Activity

The photocatalytic efficiency of the 6FDA-DMN-based catalysts was evaluated using MB as a representative pollutant. The photocatalytic setup included a reaction chamber, a white light-emitting diode (LED) light source emitting light in the 400 to 800 nm range with a power output of 100 watts (W), and a fan to maintain a consistent temperature of 22° C. within the chamber. Initially, a 100 mL solution containing 15 milligrams per liter (mg L⁻¹) of MB was introduced into the reactor, followed by the addition of 100 milligrams (mg) of a catalyst. Stirring in darkness was conducted to establish an adsorption-desorption equilibrium. The photocatalytic process initiated upon activation of the light source. 3 mL samples were withdrawn at 30-minute (min) intervals for analysis using ultraviolet-visible (UV-visible) absorption spectroscopy via a Duetta spectrofluorometer (HORIBA). To examine the photocatalytic memory effect, the reaction continued after the light source was switched off, with periodic sampling for analysis. Additionally, for samples subjected to pre-illumination, a 6-hour (h) light exposure was applied prior to the reaction under dark conditions.

### Example 6: Impedance Spectroscopy

The total impedance of the circuit was calculated as follows:

$$\begin{matrix}{Z}^{*} = {Z}^{′} + j {Z}^{″} = ( \frac{1}{R} + \frac{1}{{Z}_{CPE}^{*}} ) & ( 1 ) \\ {Z}_{CPE}^{*} = \frac{1}{{{A}_{0} ( j ω )}^{n}} & ( 2 )\end{matrix}$$

where Z* represents the total impedance of the circuit, Z′ is the real component of impedance, Z″ is the imaginary component of impedance, and Z*_{CPE} is the impedance of the constant-phase element, as shown in Eq. 1. A₀ is a frequency-independent constant, a is the angular frequency (ω=2πf), and 0<n<1 is a dimensionless parameter that determines the degree of deviation from a perfect semicircle [Bouzidi, C. and researchers, Impedance analysis of BaMo1-xWxO₄ ceramics, Superlattices Microstruct, 2015, 82, 559-573, which is incorporated herein by reference in its entirety]. A₀=C, which yields the impedance of a capacitor when n=1, as depicted in Eq. 2. The impedance curve's intercept with the Z′ axis is the resistance R. The following relationships, shown in Eq. 3 and Eq. 4, were used to fit the experimental scattered points.

$${Z}^{′} = \frac{R ( 1 + R {A}_{0} {ω}^{n} cos ( \frac{n π}{2} ) )}{1 + 2 R {A}_{0} {ω}^{n} cos ( \frac{n π}{2} ) + {( R {A}_{0} {ω}^{n} )}^{2}} \qquad ( 3 )$$

$${Z}^{″} = \frac{{R}^{2} {A}_{0} {ω}^{n} sin ( \frac{n π}{2} )}{1 + 2 R {A}_{0} {ω}^{n} cos ( \frac{n π}{2} ) + {( R {A}_{0} {ω}^{n} )}^{2}} \qquad ( 4 )$$

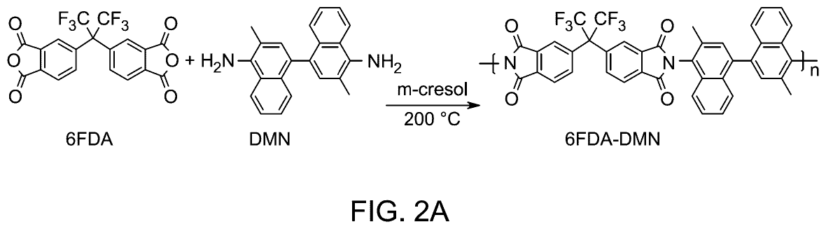

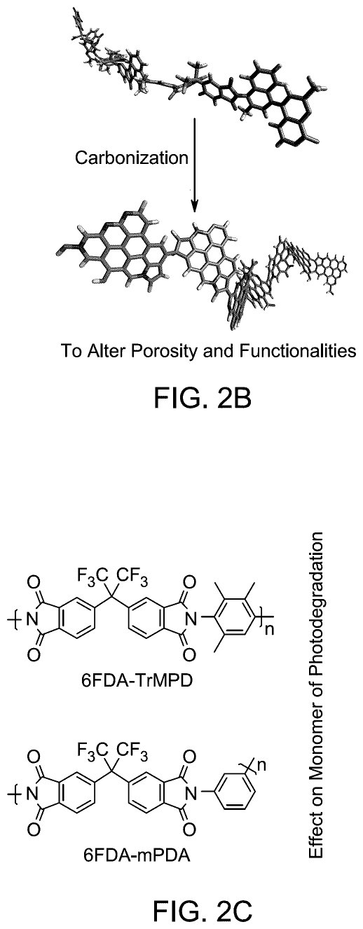

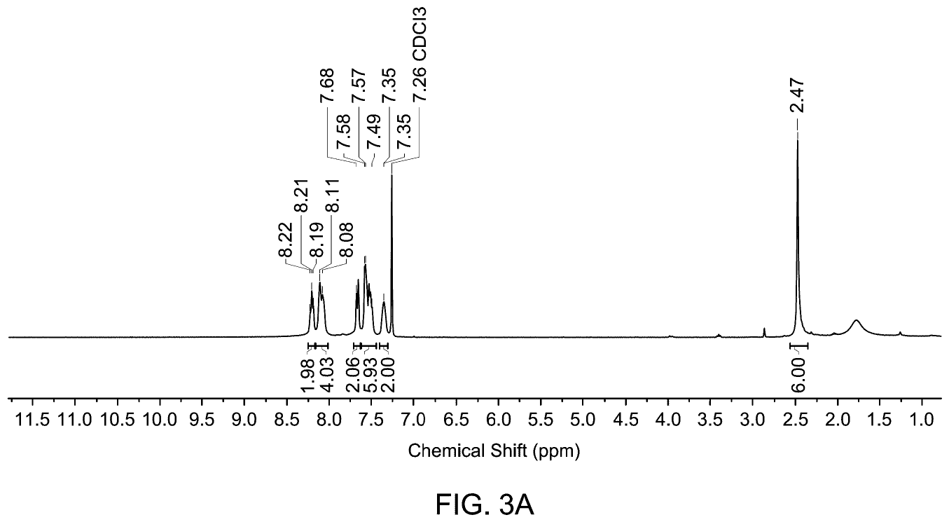

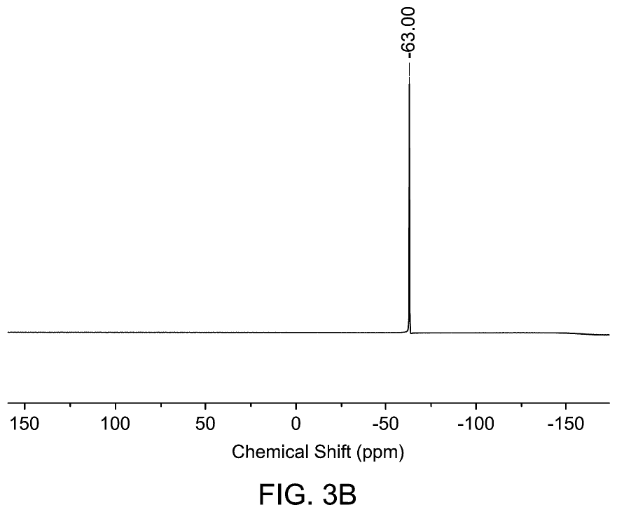

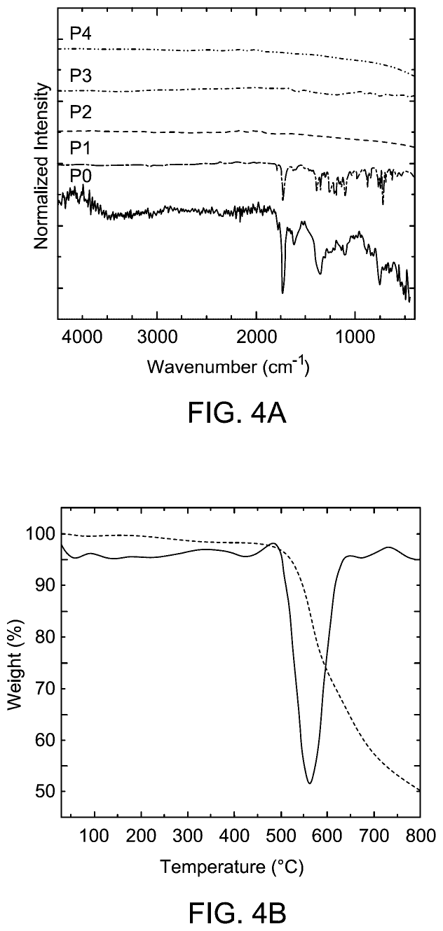

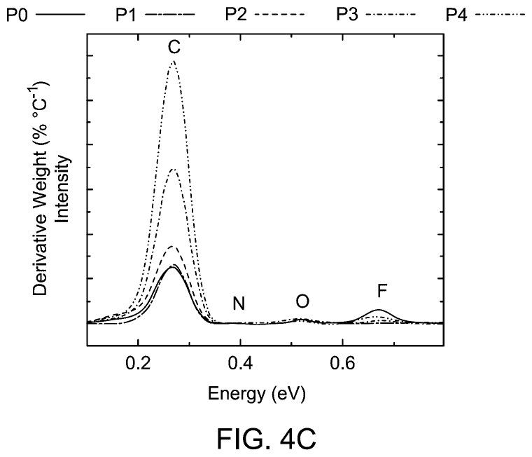

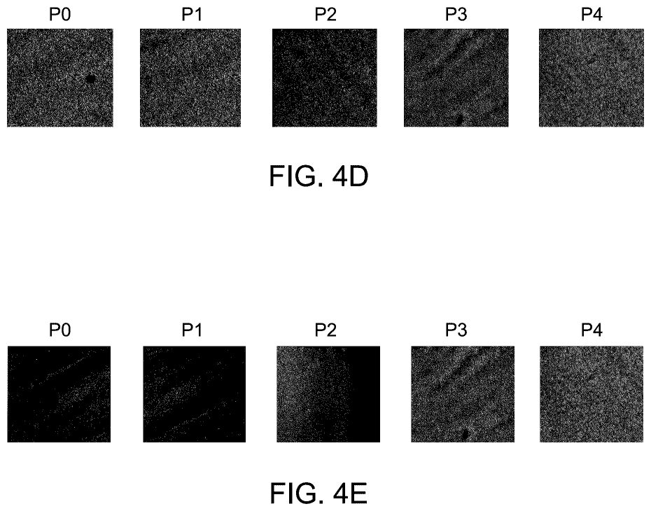

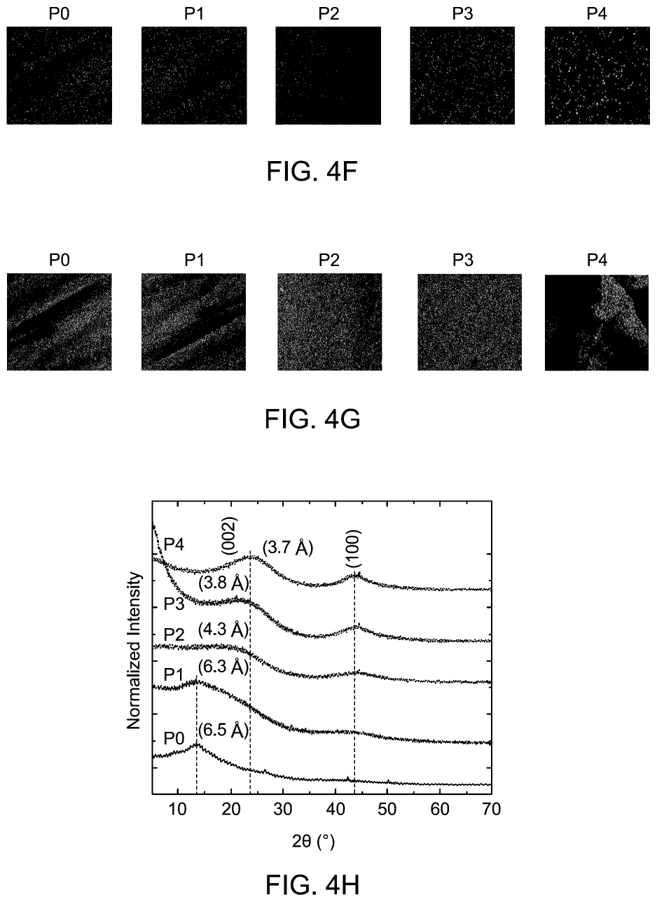

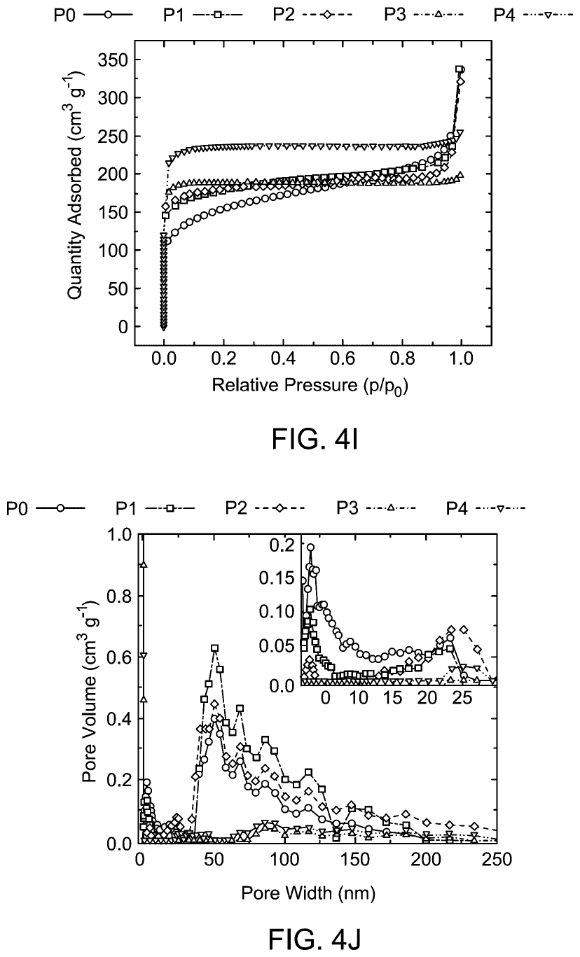

6FDA-DMN was prepared by a one-step high-temperature polycondensation reaction at 200° C. in m-cresol and in the presence of isoquinoline, as shown in FIG. 2A. FIGS. 2B-2C depict a three-dimensional (3D) structure of 6FDA-DMN and its carbonized version, and structures of porous polyimide 6FDA and 2,4,6-trimethylbenzene-1,3-diamine (6FDA-TrMPD) and porous polyimide 6FDA and m-phenylenediamine (mPDA) (6FDA-mPDA), respectively. The molecular structure of the 6FDA-DMN was confirmed by nuclear magnetic resonance (NMR), as shown in FIGS. 3A-3B, and FTIR analysis, as shown in FIG. 4A. The absence of ¹H NMR peaks above 10 parts per million (ppm) and the carboxylic acid (—COOH) stretching band in FTIR confirmed the total conversion of poly(amic) acid to polyimides. The 6FDA-DMN polymer demonstrated excellent solubility in organic solvents, as listed in Table 1, and high thermal stability with an onset decomposition temperature exceeding 500° C., making it suitable for pyrolysis at elevated temperatures, as shown in FIG. 4B. 6FDA-DMN-derived metal-free catalysts were prepared by carbonizing 6FDA-DMN polymer at a temperature above the onset decomposition, i.e., temperatures of 530° C., 600° C., 800° C., and 1000° C., to alter the functionalities and porosity of catalysts. The catalyst designation and porosity measurements are listed in Table 2.

TABLE 1
6FDA-DMN solubility in organic solvents [✓ = soluble]

| Polymer | THF | DMF | DMSO | DMAc | NMP | Acetone | m-cresol | DCM | Chloroform |
|---|---|---|---|---|---|---|---|---|---|
| 6FDA-DMN | ✓ | ✓ | ✓ | ✓ | ✓ | ✓ | ✓ | ✓ | ✓ |

TABLE 2
Sample designation, surface area, and total
pore volume of 6FDA-DMN-based catalysts

| | Pyrolysis | BET | Langmuir | Total pore |
|---|---|---|---|---|
| | temperature | surface | surface | volume |
| Sample | (° C.) | area (m² g⁻¹) | area (m² g⁻¹) | (cm³/g) |
| P0 | — | 521 | 767 | 0.33 |
| P1 | 530 | 545 | 842 | 0.32 |
| P2 | 600 | 574 | 812 | 0.31 |
| P3 | 800 | 596 | 830 | 0.29 |
| P4 | 1000 | 729 | 1044 | 0.36 |

FTIR spectra of the 6FDA-DMN and its carbonized counterpart are shown in FIG. 4A. The pristine sample, P0, displayed a C—N absorption band at 1350 cm⁻¹ whereas the bands observed at 1724 cm⁻¹ and 1789 cm⁻¹ corresponded to the symmetric and asymmetric vibration of C═O stretching in imide groups, respectively. For the carbonized samples, P1-P4, the intensities of characteristic bands become weaker with the increase in carbonization temperature, suggesting an increase in the degree of carbonization of 6FDA-DMN-based catalysts. This trend agrees with energy-dispersive X-ray (EDX) spectra, as shown in FIG. 4C, where the intensity of carbon peak increased upon increasing carbonization, reducing the intensity of other elements like carbon, nitrogen, oxygen, and fluorine, as shown in FIG. 4D, FIG. 4E, FIG. 4F, and FIG. 4G, respectively.

To further examine the effect of the pyrolysis on the resulting catalysts' morphology, WXRD analysis was carried out to identify their microstructure and inter-layer distances, as shown in FIG. 4H. All spectra exhibited broad peaks, which implies an amorphous nature. P0 demonstrated a broad peak at 2θ=13.5° with a d-spacing value of 6.5 angstroms (Å). After carbonization, a shift in the major peak was observed in which P1, P2, P3, and P4 exhibited the major peak at 2θ=13.8°, 20.6°, 23°, and 24° with a d-spacing value of 6.3 Å, 4.3 Å, 3.8 Å, and 3.7 Å, respectively, representing (d₀₀₂) in graphite [Hazazi, K. et al., Ultra-selective carbon molecular sieve membranes for natural gas separations based on a carbon-rich intrinsically microporous polyimide precursor, J. Memb. Sci., 2019, 585, 1-9; and Ismail, N. H. et al., Development and characterization of disk supported carbon membrane prepared by one-step coating-carbonization cycle, J. Ind. Eng. Chem, 2018, 57, 313-321, which are incorporated herein by references in their entireties]. Furthermore, a new peak at 2θ≈440 with a d-spacing of ~2.1 Å corresponding to the (100) plane in the graphite lattice was observed after carbonization [Fu, Y. J. et al., Development and characterization of micropores in carbon molecular sieve membrane for gas separation, Microporous Mesoporous Mater, 2011, 143, 78-86, which is incorporated herein by reference in its entirety]. This indicated a mixture of graphitic and turbostratic structures, contributing to the narrowing of pore size distribution. A turbostratic structure may be more favorable than a graphitic structure because it has more spacing between the planes due to disordered arrangements of the molecules, which means high porosity and surface area; however, lower d-spacing means lower inter-plane distances, providing excellent molecular sieving properties, which is a high-demand property in the synthesis of gas separation materials [Liu, Y. et al., Advanced organic molecular sieve membranes for carbon capture: Current status, challenges and prospects, Adv. Membr, 2022, 2, 100028, which is incorporated herein by reference in its entirety].

Porosity remains a factor for efficient catalytic activities due to the importance of surface area; therefore, nitrogen adsorption isotherms were measured at −196° C., as shown in FIG. 4I, along with their corresponding pore size distributions, as shown in FIG. 4J. All 6FDA-DMN-based catalysts displayed a typical type II isotherm with a rapid increase at a relatively low p/po region (<0.05), which was mainly ascribed to the existence of microporous structures [Liu, Y. and researchers, Advanced organic molecular sieve membranes for carbon capture: Current status, challenges and prospects, Adv. Membr, 2022, 2, 100028, which is incorporated herein by reference in its entirety]. It was observed that as the pyrolysis temperature increased, the BET surface area increased. For instance, P0 demonstrated a BET surface area of 521 m²/g, which increased by 40% upon carbonization at 1000° C. for P4 having a BET surface area of 729 m²/g. Furthermore, the total pore volumes at a relative pressure p/po of 0.85 were varied between 0.31 and 0.34 for all samples. Additionally, the pore size distribution, as shown in FIG. 4J, revealed that carbonizing 6FDA-DMN facilitated the formation of small pores in the carbon molecular sieve structure, indicating pore shrinkage and chain tightening. The polymer was carbonized in order to enhance its surface area and improve its adsorption properties and catalytic activities.

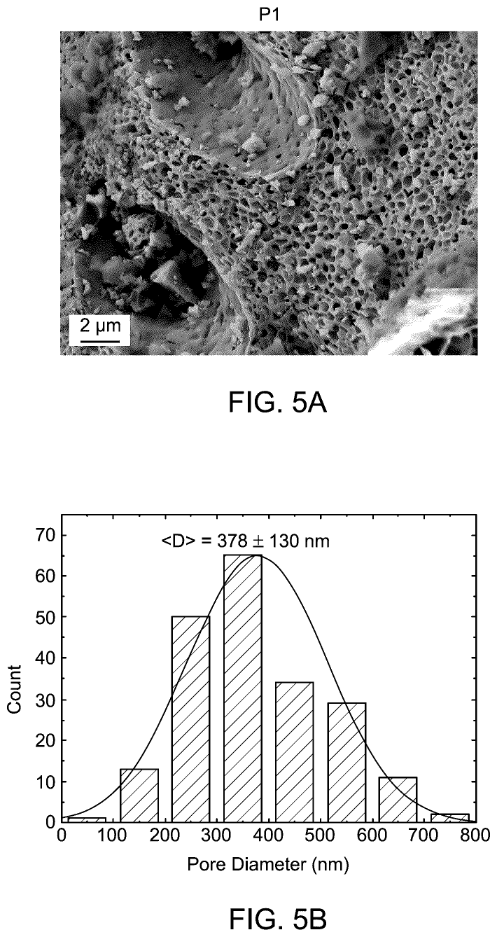

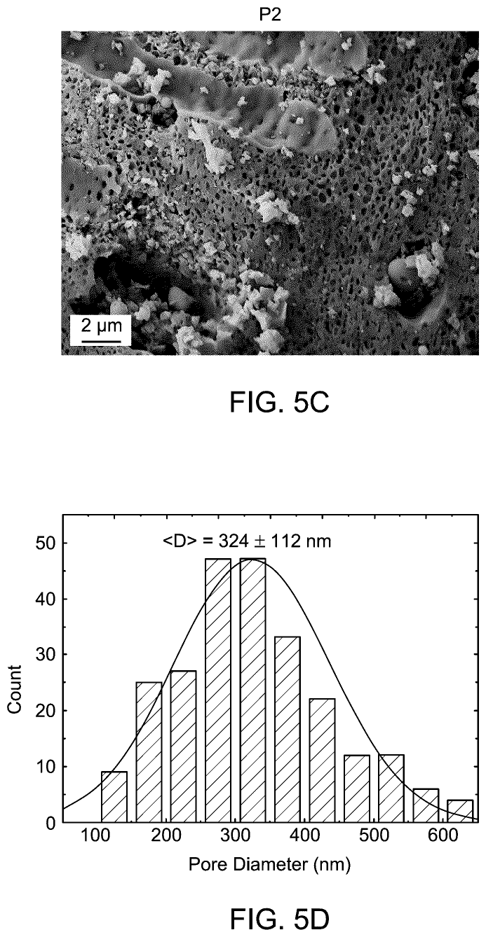

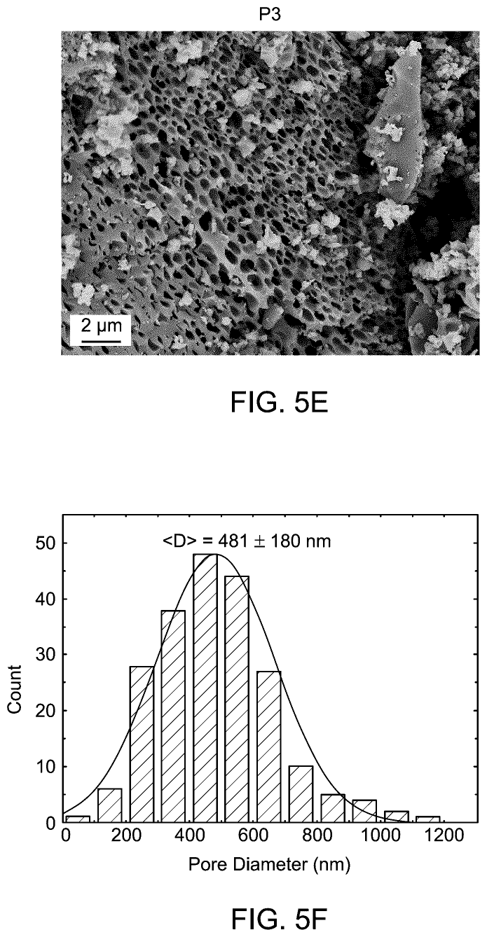

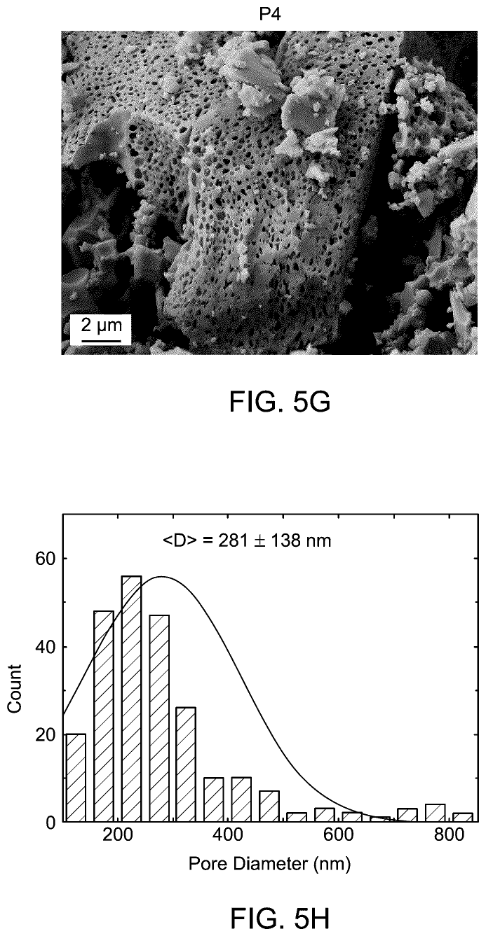

The surface morphology of the 6FDA-DMN-based catalysts P1, P2, P3, and P4 was characterized by SEM analysis, as shown in FIG. 5A, FIG. 5C, FIG. 5E, and FIG. 5G, respectively. The corresponding pore size distribution is shown in FIG. 5B, FIG. 5D, FIG. 5F, and FIG. 5H, respectively. The carbonized samples exhibited surface porosity with average pore diameter ranges between 281 and 481 nm. No clear trend was observed for the pore size changes at the surface of the catalysts; however, it was observed that increasing the temperature from 530 to 800° C. led to an increase in pore diameter from 378 nm to 481 nm, which may be attributed to the chain rearrangement and graphite formation at elevated temperatures. The average diameter was decreased upon increasing the temperature to 1000° C. This reduction in pore diameter may be attributed to chain compaction and reduction in internal d-spacing as noted from WXRD, where P4 displayed a higher intensity peak at 2θ≈440 with a d-spacing of ~2.1 Å, representing further shrinkage in pores at high temperature.

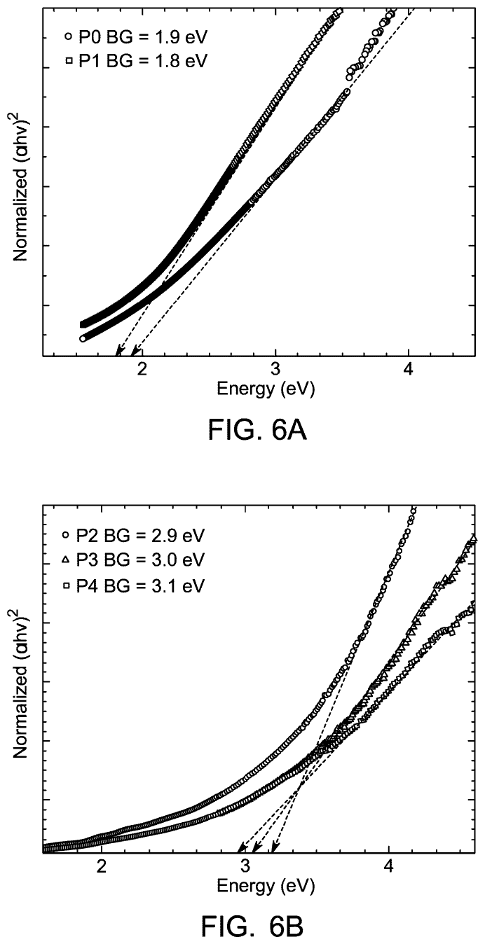

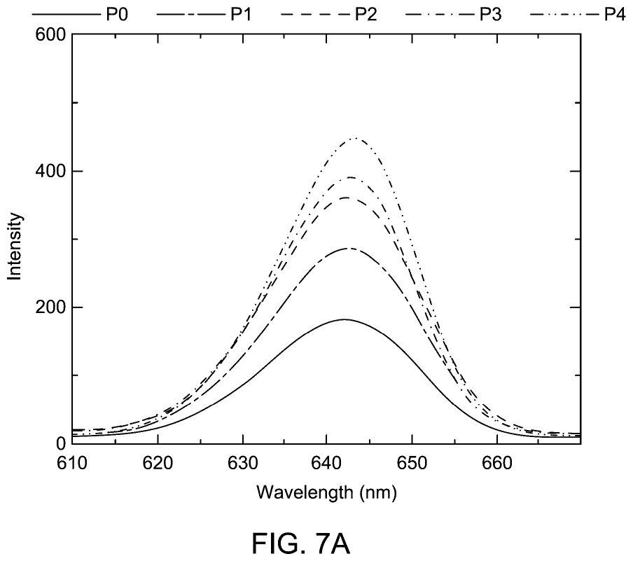

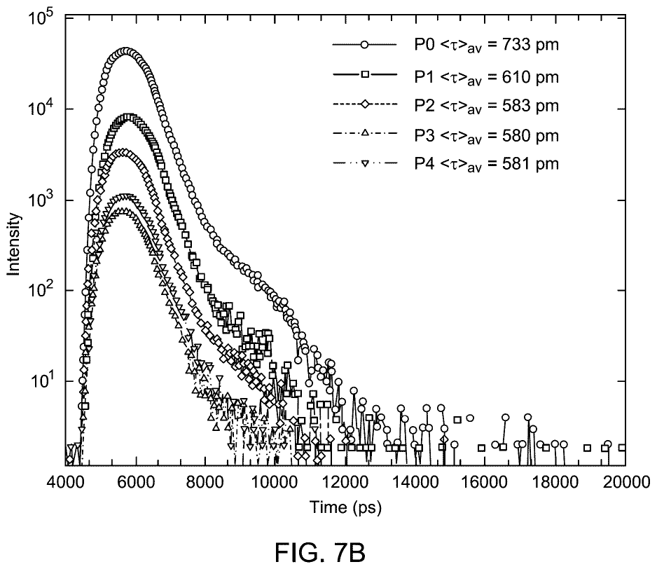

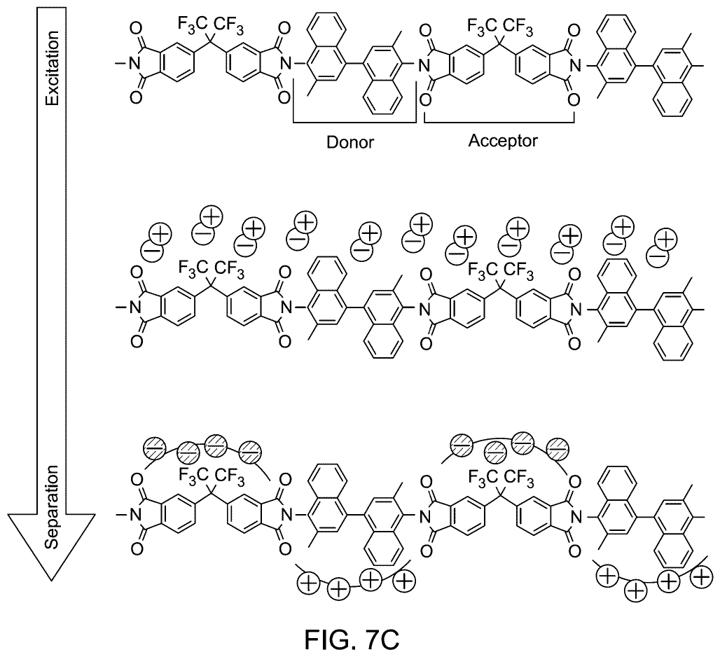

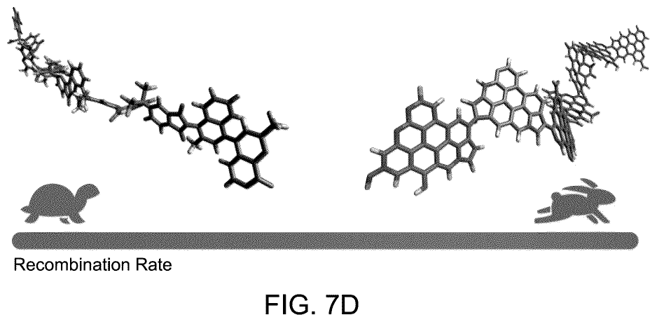

To evaluate photocatalytic capabilities of synthesized catalysts, methylene blue (MB) was used as a model pollutant during visible light exposure. Before conducting the photocatalytic experiments, optical bandgaps were determined through Tauc plots, as shown in FIGS. 6A-6B, revealing bandgap values of 2.9 eV, 2.8 eV, 2.9 eV, 3.0 eV, and 3.1 eV for P0, P1, P2, P3, and P4, respectively. FIG. 7A is a photoluminescence (PL) spectrum of the prepared materials. FIG. 7B depicts decay spectra of P0-P4. FIG. 7C is a schematic representation of the excitation and separation state of P0 depicting effects of the acceptor-donor structure in the polymer backbone. FIG. 7D is a recombination rate illustration going from pristine material to carbonized structures.

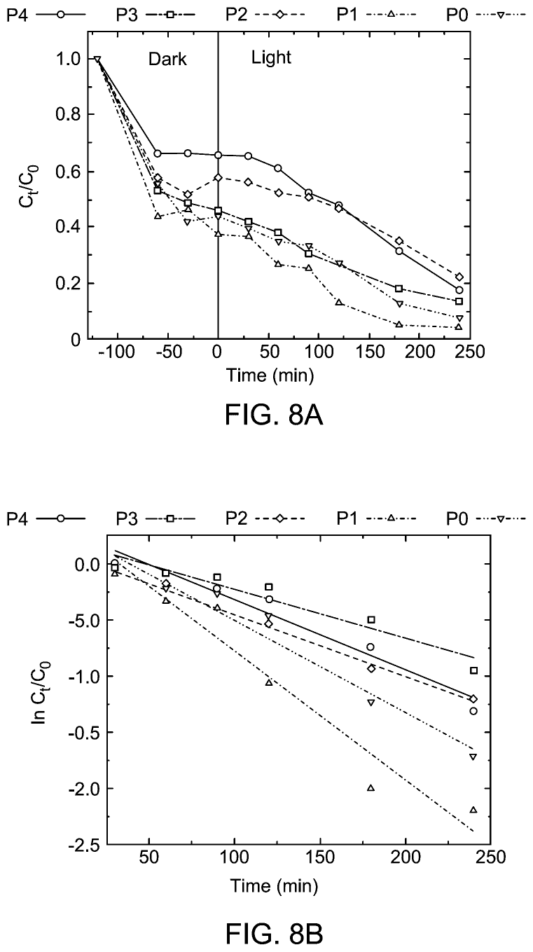

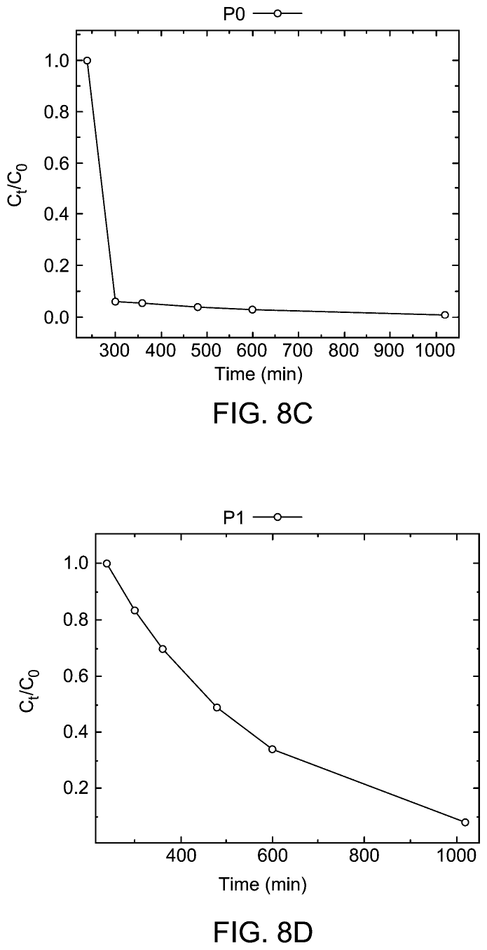

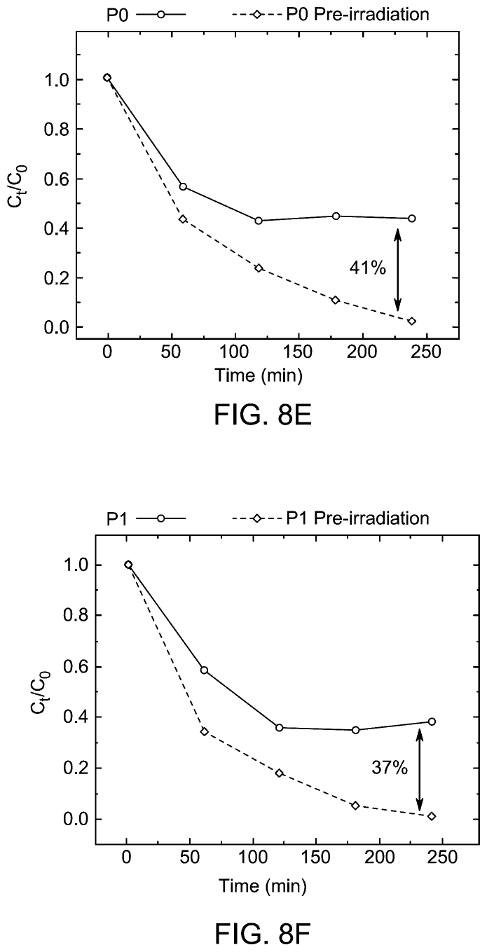

A control experiment was conducted to measure degradation of MB in an aqueous solution without a photocatalyst exposed to visible light for 6 h which indicated negligible photolysis of MB. Adsorption capacity of the catalysts was measured in the dark for 2 h before the photocatalytic degradation test, as shown in FIG. 8A. P0 effectively eliminated around 60% of the dye. The catalysts demonstrated adsorption capacities (Q_{ads}) of 8.7 mg/g, 9.7 mg/g, 5.47 mg/g, 6.12 mg/g, and 3.87 mg/g for P0, P1, P2, P3, and P4, respectively. P0 and P1 exhibited the highest adsorption capacity in the absence of light, with dye removal efficiencies of 56% and 63%, respectively. Materials carbonized at higher temperatures (i.e., P2, P3, and P4) demonstrated lower adsorption efficiency, attributed to the loss of polar functional groups during pyrolysis; however, the 6FDA-DMN-based catalysts displayed good photoactive properties under visible light, owing to their acceptor-donor polymer nature [Chu, S. et al., Band structure engineering of a polyimide photocatalyst towards enhanced water splitting, Energy Adv, 2023, 2, 556-564, which is incorporated herein by reference in its entirety]. P0-P4 showcased photocatalytic activity under visible light, with MB photodegradation efficiencies ranging between 61% and 89% (FIG. 8A). Functional groups play a role in photocatalytic efficiency, while carbonization, although increasing porosity, diminishes photocatalytic activity due to the absence of functional groups.

The kinetics of MB degradation using 6FDA-DMN-based catalysts were assessed and illustrated in FIG. 8B and Table 3. All catalysts followed pseudo-first-order kinetics exhibiting degradation rates ranging from 0.004 min⁻¹ to 0.0114 min⁻¹. P0 and P1 demonstrated shorter half-times, defined as the time to degrade half the initial quantity of MB, compared to the other samples, indicating their rapid photocatalytic degradation behavior.

TABLE 3
MB photodegradation kinetic parameters

| Sample | K₁ (min⁻¹) × 10⁻² | Half-time (min) | R² |
|---|---|---|---|
| P0 | 0.62 | 85 | 0.95 |
| P1 | 0.55 | 61 | 0.99 |
| P2 | 0.43 | 161 | 0.92 |
| P3 | 1.14 | 126 | 0.95 |
| P4 | 0.82 | 112 | 0.95 |

Upon the cessation of light irradiation, which was after a 4 hour exposure period, a shift in the behavior of MB concentration evolution in the dark was noted in the P0 and P1 samples. FIG. 8C and FIG. 8D depict continuous photodegradation of MB in dark conditions using P0 and P1, respectively (memory effect representation). Despite the absence of light, the gradual disappearance of MB dye continued to occur, as shown in FIGS. 8C-8D and Table 4. This persistent degradation displays a memory effect embedded within the polymer structures, where the photocatalytic activity persisted in the absence of external light stimulation. In response to this observation, a series of pre-irradiation experiments and analyses were conducted to examine the underlying mechanisms and further elucidate this phenomenon.

TABLE 4
MB adsorption and photodegradation over prepared polymers

| | Adsorption | Photodegradation | Light Off |
|---|---|---|---|
| Sample | (Dark) (%) | (light) (%) | (Dark) (%) |
| P0 | 56 | 82 | 88 |
| P1 | 63 | 89 | 92 |
| P2 | 42 | 61 | ~2 |
| P3 | 54 | 86 | ~0 |
| P4 | 34 | 73 | ~0 |
| 6FDA-TrMPD | 23 | 54 | ~0 |
| 6FDA-mPDA | 22 | 43 | ~28 |

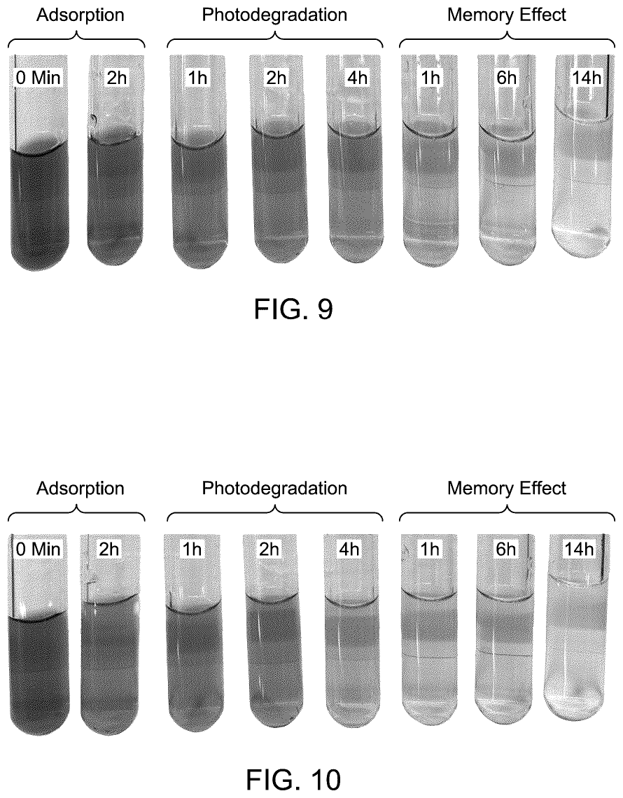

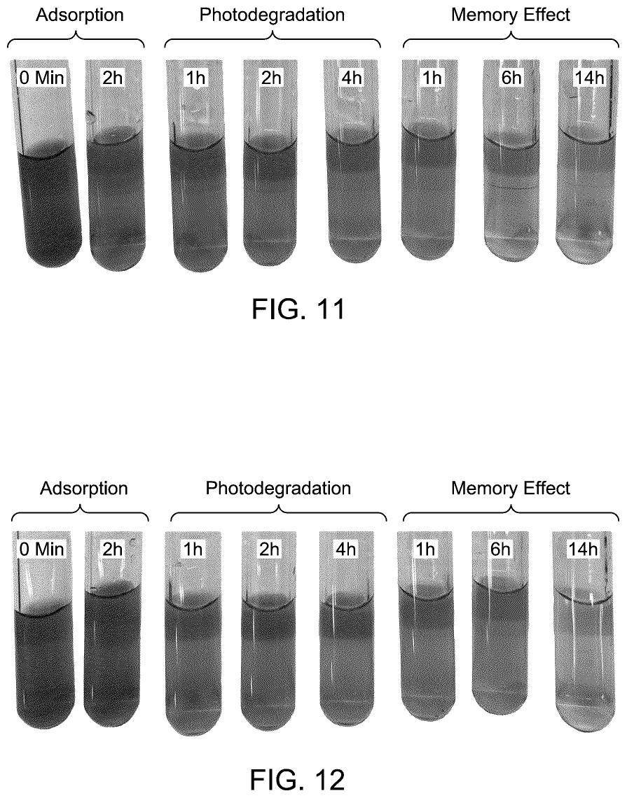

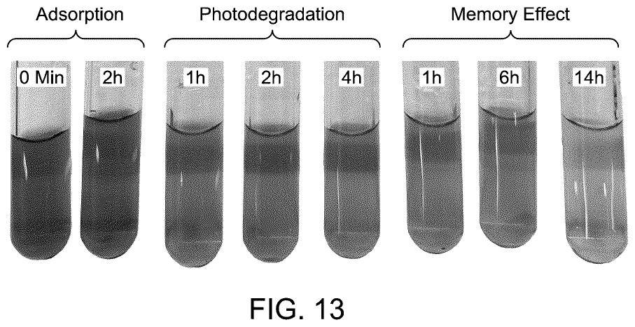

FIG. 8E and FIG. 8F show the effect of pre-irradiation of P0 and P1, respectively, in a solid state on the photodegradation of MB in dark. Among the 6FDA-DMN-based catalysts examined in the present disclosure, both P0 and P1 demonstrated sustained photocatalytic activity that persisted after the cessation of light exposure for up to 14 h. Various methodologies have been employed to assess persistent photocatalysis, demonstrating performance even under dark conditions [Li, J. et al., A full-sunlight-driven photocatalyst with super long-persistent energy storage ability, Sci. Reports, 2013, 31, 3, 1-6, which is incorporated herein by reference in its entirety]. One such approach involves maintaining the reaction post-light-off and monitoring dye degradation over a specified duration. Following the photodegradation process, the light source was deactivated, and the catalysts were left in contact with the remaining dye in the solution. Particularly, a gradual disappearance of dye color was observed over the course of 14 h, resulting in the degradation of approximately 90% of the residual dye, as seen in FIGS. 8C-8D and FIGS. 9-13.

To determine the memory effect in P0 and P1, both catalysts underwent pre-illumination by exposure to visible light for 4 h in their solid state before being applied to the dye solution under dark conditions [Zhang, Q. et al., Metal-free photocatalyst with visible-light-driven post-illumination catalytic memory, ACS Appl. Mater. Interfaces, 2017, 9, 21738-21746, which is incorporated herein by reference in its entirety]. The dye concentration gradually decreased until it reached its maximum reduction. P0 demonstrated a 41% decline compared to the blank samples (non-irradiated), while P1 exhibited a 37% decline in dye concentration, as seen in FIGS. 8E-8F. This observation supports the memory effect, wherein the polymers retained the effects of light exposure and subsequently released it gradually to degrade the dye molecules.

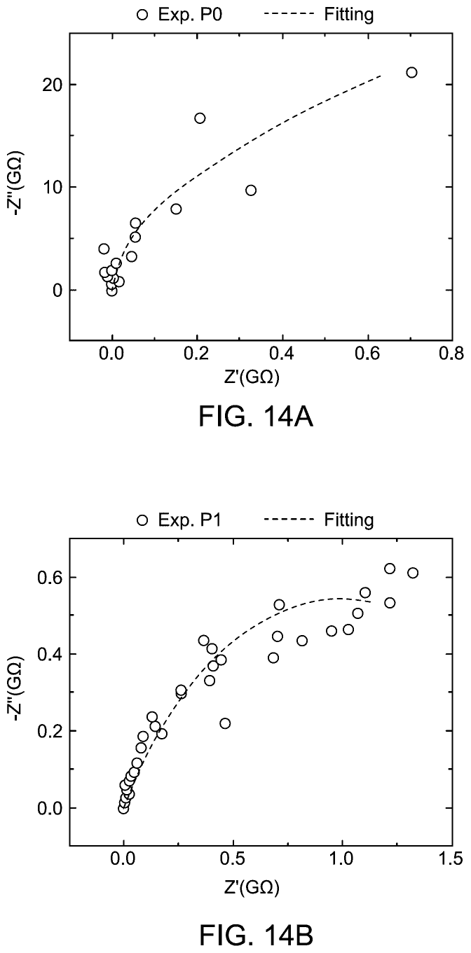

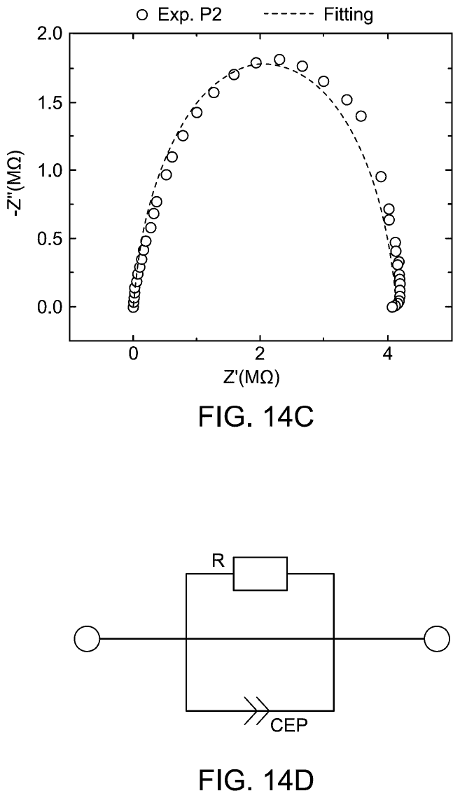

To further validate the memory effect resulting from 6FDA-DMN-based catalysts, impedance spectroscopy was used to compare the duration of charge release. The Nyquist diagram (spectra of the real and imaginary parts of the complex impedance, Z* (Z*=Z′+jZ″; j²=−1), as a function of the exciting frequency, is shown in FIGS. 14A-14C to depict the electrical response of the samples. P0-P2 exhibited similar curve patterns, with experimental points dispersed and forming a roughly circular arc. This behavior suggests the presence of an electric dipole, potentially created by a resistance connected in parallel to a capacitor; however, a simple model including only a resistance and a capacitor element is inadequate to fully explain the results as the scattered points do not align into half circles. It is commonly understood that incorporating a constant phase element (CPE) in parallel with resistance (R) provides a more accurate representation of the circuit-fitting parameters. FIG. 14D depicts an equivalent electrical circuit of the catalysts, with the best fit depicted in FIGS. 14A-14C.

The maximum imaginary impedance spectrum, Z″, decreased by around three orders of magnitude from giga Ohm (GQ) to mega Ohm (GQ) as the temperature rises from ambient to 600° C. Additionally, it demonstrated that while the capacitance roughly stays constant in nanoFarad (nF), the temperature causes the resistance R to decrease from tera ohm to mega ohm. The extracted parameters from the fit for the circuit elements are listed in Table 5. A time constant, r, lifetime at the semiconductor's depletion layer for each sample was determined by multiplying the resistance by the capacitance of the prescribed loop.

TABLE 5
Resistance, capacitance, and lifetime
of 6FDA-DMN based catalysts

| Catalyst | R (MΩ) | C (nF) | τ (s) |
|---|---|---|---|
| P0 | 7.56 × 10⁵ | 0.08024 | 60.66 |
| P1 | 2 × 10³ | 0.538 | 1.07 |
| P2 | 4.151 | 0.301 | 1.25 × 10⁻³ |

Since a capacitor does not experience instantaneous energy charging (storage) or discharging (release), the tau (τ) parameter may be thought of as the amount of time needed to charge or discharge the capacitor within a specific percentage of its full supply. Accordingly, the τ parameter measures the amount of time that photogenerated charges are still present at the semiconductor interface and can produce reactive oxygen species that can break down dyes. P0 demonstrated the highest T value of 60.66 s, indicating its potential to store and release energy over a period. P2 showed speedy storage/release of energy within 1.25 milliseconds (ms), indicating poor capability of round-the-clock degradation of the dyes.

To gain a more comprehensive understanding of the observed memory effect, an experiment correlating structure with phenomena was undertaken to elucidate the observation. This examination sought to determine whether the memory effect is influenced by the porous structure or the chemical composition of the polymer. Two polyimides sharing a common backbone were examined, with variations in the diamine component, as shown in FIGS. 2A-2C. The selected structures differ solely in terms of porosity: 6FDA-mPDA was nonporous, while 6FDA-TrMPD features a porous structure. 6FDA-TrMPD demonstrated a photocatalytic degradation efficiency of approximately 54%, in the presence of light, with the reaction continuing after no illumination to degrade 28% of the remaining dye. 6FDA-mPDA demonstrated a degradation efficiency of 43% under light, with minimal photodegradation occurring after turning the lighting off. Both 6FDA-mPDA and 6FDA-TrMPD have the same chemical composition and functional groups, but they differ in porosity; therefore, porosity may increase the capability of the catalyst to store energy and allow photodegradation of the dyes in the dark.

Electrical, optical, and redox characteristics of polymers were tuned by increasing the number of benzyl units in the polymer's backbone that donate electrons, which enhances the photocatalytic oxygen evolution capability [Lan, Z. A. et al., Photocatalytic oxygen evolution from functional triazine-based polymers with tunable band structures, Angew. Chemie—Int. Ed., 2018, 57, 470-474, which is incorporated herein by reference in its entirety]. To evaluate the effect of benzyl rings on the photodegradation in the dark, 6FDA-TrMPD was used for comparison. The two polyimides, which include 6FDA-DMN and 6FDA-TrMPD, were made from the same dianhydride (6FDA) and different diamines DMN and TrMPD. Both polymers demonstrated similar BET surface areas of approximately 550 m²/g. Any changes in the memory effect may be a result of monomer chemical structures, mainly the presence of benzyl rings and conjugation.

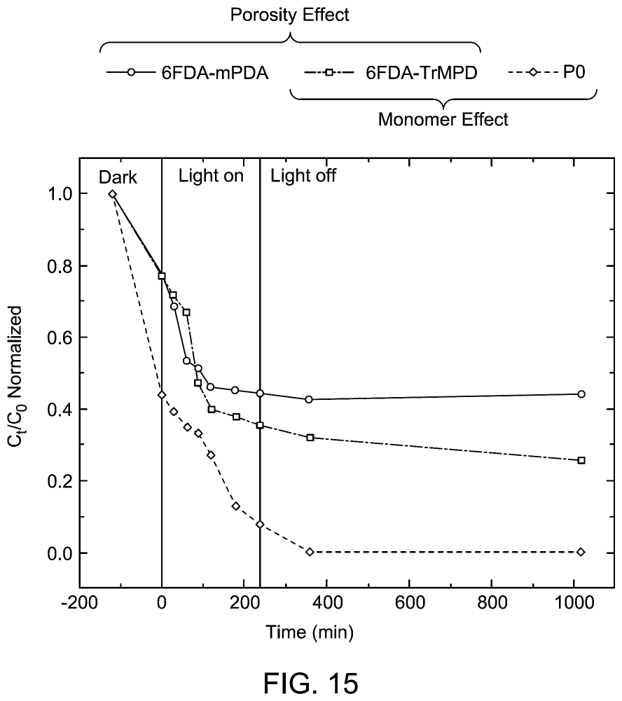

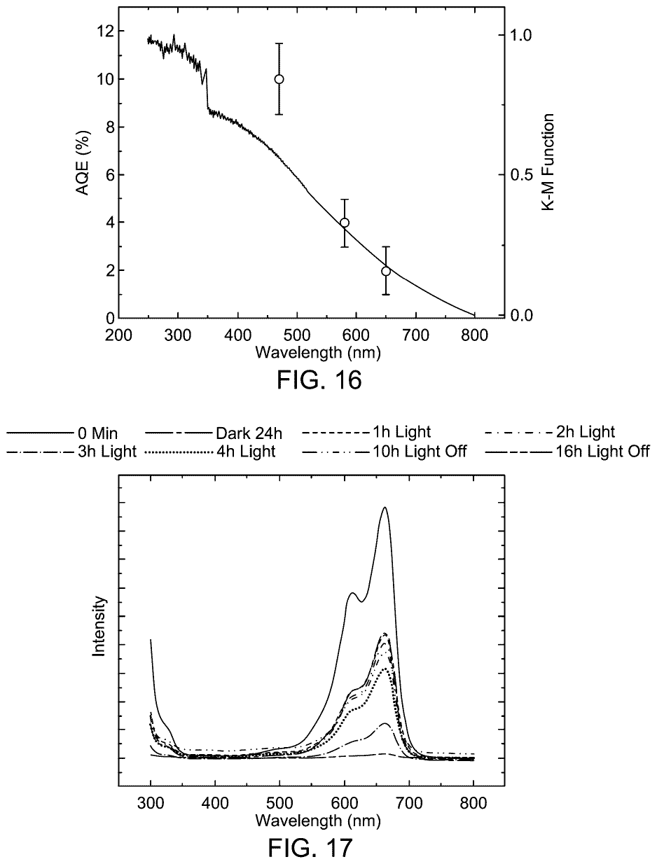

Before conducting photodegradation experiments, the adsorption efficiency of MB was assessed, revealing values of 56% and 23% for 6FDA-DMN and 6FDA-TrMPD, respectively, as shown in FIG. 15. Subsequently, a disparity in photodegradation efficiency emerged after illuminating the catalysts for 4 h. 6FDA-DMN achieved an 82% degradation of the remaining dye under light, while 6FDA-TrMPD managed 54%. During post-light exposure, 6FDA-DMN continued to degrade dye for up to 12 hours, reaching an 88% degradation of the remaining dye, whereas 6FDA-TrMPD exhibited a lesser capability, degrading 28% of the remaining dye. These findings suggest that both polymers possess the capacity to store energy and release it in the dark; however, the memory effect was more pronounced in 6FDA-DMN compared to 6FDA-TrMPD. The presence of more benzyl rings in DMN monomer was helpful for increasing the memory effect capability. These results contribute to a deeper understanding of the influence of porosity and functional groups on the memory effect and dye degradation. The present disclosure sets the stage for the further development of metal-free catalysts for round-the-clock photodegradation and the exploration of methods to enhance their performance. FIG. 16 shows apparent quantum yield as a function of the incident light wavelength during MB degradation over P1. The graph highlights how the AQY varies with different wavelengths of light, providing insights into the efficiency of the photocatalytic process. FIG. 17 is a UV spectrum for the degradation of MB in the presence and absence of light.

Metal-free catalysts derived from polyimides with intrinsic microporosity were synthesized and evaluated for the photocatalytic degradation of methylene blue (MB). These catalysts exhibited surface areas ranging from 521 to 729 m²/g and demonstrated photocatalytic efficacy under visible light irradiation. Pristine 6FDA-DMN and the catalyst prepared via thermal annealing at 530° C. showed the highest efficiency in MB degradation. These catalysts showcased a photocatalytic memory effect, enabling continuous photodegradation round-the-clock, attributed to a synergistic interplay of porosity, functional groups, and the presence of benzene rings within the polymer matrix. The nonporous polyimide (6FDA-mPDA) served as a standard, lacking any memory effect, highlighting the role of porosity in this phenomenon. A comparison with porous polyimide (6FDA-TrMPD), possessing similar porosity but differing in the number of benzyl rings on the diamine molecule, revealed a less efficient yet present memory effect compared to 6FDA-DMN.

Numerous modifications and variations of the present disclosure are possible in light of the above teachings. It is, therefore, to be understood that within the scope of the appended claims, the disclosure may be practiced otherwise than as specifically described herein.

1. A method of dye degradation, comprising:
A. providing a metal-free catalyst comprising a carbonized polyimide material, wherein the metal free catalyst is made by a method comprising:
1. combining equimolar amounts of 4,4′-(hexafluoroisopropylidene) diphthalic anhydride (6FDA) and 3,3′-dimethyl-naphthidine (DMN) in m-cresol, with isoquinoline as a catalyst;
2. increasing the temperature to 200° C. to facilitate complete imidization and full conversion of poly(amic) acid to polyimide;
3. precipitating the polyimide by addition of methanol to yield polyimide 6FDA-DMN fibers;
4. pyrolyzing the polyimide 6FDA-DMN fibers by heating at a rate of 2° C. per minute (° C. min⁻¹) to a temperature of from 780° C. to 820° C., followed by an isothermal treatment at a temperature of from 780° C. to 820° C. for one hour, followed by cooling naturally to room temperature to provide the carbonized polyimide material;
wherein the carbonized polyimide material has a BET surface area of 590 to 600 m²/g, a Langmuir surface area of 825 to 835 m²/g, a total pore volume of 0.28 to 0.3 cm³/g, and a bandgap value of 2.9 to 3.1 electron volts (eV);
B. combining the metal-free catalyst with a solution comprising methylene blue (MB) dye in a reaction chamber;
irradiating the reaction chamber with light; and
degrading the MB dye.

2. The method of claim 1, wherein the metal-free catalyst has an MB dye degradation efficiency of from 60% to 90% based on an initial concentration of MB dye in the solution.

3-14. (canceled)

15. The method of claim 1, wherein irradiating the reaction chamber with light occurs for 5 to 1200 min.

16-20. (canceled)

21. The method of claim 1, wherein the polyimide fibers have Fourier-transform infrared (FTIR) spectroscopy absorption peaks at 1789 wavenumbers (cm⁻¹), 1724 cm⁻¹, and 1350 cm⁻¹, corresponding to an asymmetric C═O stretch, a symmetric C═O stretch, and a C—N stretch, respectively.

22. The method of claim 21, wherein the polyimide fibers have a number-average molecular weight (Mₙ) of 68,000 g/mol, a molecular weight (M_{w}) of 84,000 g/mol, and a polydispersity index of 1.23.

23. The method of claim 1, wherein the carbonized polyimide material has a BET surface area of 595 m²/g, a Langmuir surface area of 830 m²/g, a total pore volume of 0.29 cm³/g, and a bandgap value of 3.0 electron volts (eV).

24. The method of claim 1, wherein the MB dye is degraded at a rate K1 of from 0.0082 min⁻¹ to 0.114 min⁻¹.
